(19) United States
(12) Patent Application Publication
(10) Pub. No.: US 2026/0029690 A1
(43) Pub. Date: Jan. 29, 2026

(54) OPTICAL IMAGING SYSTEM

(71) Applicant: Samsung Electro-Mechanics Co., Ltd., Suwon-si (KR)

(72) Inventors: Hag Chul KIM, Suwon-si (KR); Phil Ho JUNG, Suwon-si (KR); Seong Il CHO, Suwon-si (KR)

(73) Assignee: Samsung Electro-Mechanics Co., Ltd., Suwon-si (KR)

(21) Appl. No.: 19/057,282

(22) Filed: Feb. 19, 2025

(30) Foreign Application Priority Data
Jul. 29, 2024 (KR) 10-2024-0099987

(51) Int. Cl. G03B 17/17

(52) U.S. Cl. CPC G03B 17/17

(57) ABSTRACT

An optical imaging system includes a first lens group, a second lens group, a third lens group, and a fourth lens group sequentially arranged in ascending numerical order along an optical axis of the optical imaging system from an object-side of the optical imaging system toward an imaging plane of the optical imaging system; and a reflective member disposed between the first lens group and the second lens group, wherein the second lens group and the fourth lens group are each configured to be movable along the optical axis, the first lens group has a positive refractive power, and the optical imaging system satisfies the conditional expression −3.5<fG1/fG2<−2, where fG1 is a focal length of the first lens group, and fG2 is a focal length of the second lens group.

### CROSS-REFERENCE TO RELATED APPLICATIONS

This application claims the benefit under 35 USC 119(a) of Korean Patent Application No. 10-2024-0099987 filed on Jul. 29, 2024, in the Korean Intellectual Property Office, the entire disclosure of which is incorporated herein by reference for all purposes.

### BACKGROUND

### 1. Field

The present disclosure relates to an optical imaging system.

### 2. Description of Background

Camera modules have become standard features in portable electronic devices, including smartphones.

In addition, a method of mounting a plurality of camera modules having different focal lengths in a portable electronic device has been proposed in order to indirectly implement an optical zoom effect.

However, this method requires a plurality of camera modules for the optical zoom effect, and since there is a difference in the fields of view between the plurality of camera modules, image processing via software rather than an optical zoom is required when imaging at an intermediate magnification, thereby degrading image quality.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, an optical imaging system includes a first lens group, a second lens group, a third lens group, and a fourth lens group sequentially arranged in ascending numerical order along an optical axis of the optical imaging system from an object-side of the optical imaging system toward an imaging plane of the optical imaging system; and a reflective member disposed between the first lens group and the second lens group, wherein the second lens group and the fourth lens group are each configured to be movable along the optical axis, the first lens group has a positive refractive power, and the optical imaging system satisfies the conditional expression −3.5<fG1/fG2<−2, where fG1 is a focal length of the first lens group, and fG2 is a focal length of the second lens group.

The first lens group may include a first lens and a second lens sequentially arranged in ascending numerical order along the optical axis from an object side of the first lens group toward the imaging plane, and one of the first lens and the second lens may have an Abbe number of 50 or more, and another one of the first lens and the second lens may have an Abbe number of 25 or less.

The first lens and the second lens may have refractive powers of opposite signs, and among the first lens and the second lens, the lens having an Abbe number of 50 or more may have a positive refractive power, and the lens having an Abbe number of 25 or less may have a negative refractive power.

The optical imaging system may satisfy the conditional expression 0.1<air_T12<2.5, where air_T12 is a distance along the optical axis from an image-side surface of the first lens to an object-side surface of the second lens.

The optical imaging system may satisfy the conditional expression 0.1<fw/f2<2.0, where fw is a total focal length of the optical imaging system in a wide-angle mode, and f2 is a focal length of the second lens.

The second lens group may have a negative refractive power and may include a plurality of lenses, and one of the plurality of lenses of the second lens group may have a biconcave shape.

The optical imaging system may satisfy the conditional expression 0.6<fc/fG2<1.0, where fc is a focal length of the lens having the biconcave shape among the plurality of lenses of the second lens group, and fG2 is the focal length of the second lens group.

The second lens group may include a third lens, a fourth lens, and a fifth lens sequentially arranged in ascending numerical order along the optical axis from an object side of the second lens groups toward the imaging plane, and the optical imaging system may satisfy the conditional expression 0.1<air_T45<1.0, where air_T45 is a distance along the optical axis from an image-side surface of the fourth lens to an object-side surface of the fifth lens.

The optical imaging system may satisfy the conditional expression 0.1<fw/f5<2.0, where fw is a total focal length of the optical imaging system in a wide-angle mode, and f5 is a focal length of the fifth lens.

The first lens group may include a first lens and a second lens sequentially arranged in ascending numerical order along the optical axis from an object side of the first lens group toward the imaging plane, the second lens group may include a third lens, a fourth lens, and a fifth lens sequentially arranged in ascending numerical order along the optical axis from an object side of the second lens group toward the imaging plane, and the optical imaging system may satisfy the conditional expressions 0.1<n1−n2<0.2 and 0.08<n5−n4<0.2, where n1 is a refractive index of the first lens, n2 is a refractive index of the second lens, n4 is a refractive index of the fourth lens, and n5 is a refractive index of the fifth lens.

The third lens group and the fourth lens group each may have a positive refractive power.

The optical imaging system further may include a stop disposed between the second lens group and the third lens group, he third lens group may include a plurality of lenses, and among the plurality of lenses of the third lens group, a lens disposed closest to the stop may have a positive refractive power.

The optical imaging system may satisfy the conditional expression 0.4<DS/TTL<0.65, where DS is a distance along the optical axis from an object-side surface of the first lens group to the stop, and TTL is a distance along the optical axis from the object-side surface of the first lens group to the imaging plane.

The optical imaging system may satisfy the conditional expression 0.45<DS/fG1<1.0, where DS is a distance along the optical axis from an object-side surface of the first lens group to the stop, and fG1 is a focal length of the first lens group.

The optical imaging system may satisfy the conditional expression −0.6<fG2/fG3<−0.2, where fG2 is the focal length of the second lens group, and fG3 is the focal length of the third lens group.

The first lens group may include a first lens and a second lens sequentially arranged in ascending numerical order along the optical axis of from an object-side of the first lens group toward the imaging plane, the second lens group may include a third lens, a fourth lens, and a fifth lens sequentially arranged in ascending numerical order along the optical axis of from an object-side of the second lens group toward the imaging plane, the third lens group may include a sixth lens and a seventh lens sequentially arranged in ascending numerical order along the optical axis of from an object-side of the third lens group toward the imaging plane, the fourth lens group may include an eighth lens, and the optical imaging system may satisfy the conditional expression −0.9<L8Sag_1−L8Sag_1/2<−0.01, where L8Sag_1 is a sag value of an object-side surface of the eighth lens at an effective diameter of the object-side surface of the eighth lens, and L8Sag_1/2 is a sag value of the object-side surface of the eighth lens at one half of the effective diameter of the object-side surface of the eighth lens.

Other features and aspects will be apparent from the following detailed description, the drawings, and the claims.

### BRIEF DESCRIPTION OF DRAWINGS

FIG. 1A is a diagram illustrating a wide-angle mode of an optical imaging system according to a first embodiment in the present disclosure.

FIG. 1B is a diagram illustrating a telephoto mode of the optical imaging system according to the first embodiment in the present disclosure.

FIG. 2A is a diagram illustrating aberration characteristics of the optical imaging system illustrated in FIG. 1A.

FIG. 2B is a diagram illustrating the aberration characteristics of the optical imaging system illustrated in FIG. 1B.

FIG. 3A is a diagram illustrating a wide-angle mode of an optical imaging system according to a second embodiment in the present disclosure.

FIG. 3B is a diagram illustrating a telephoto mode of the optical imaging system according to the second embodiment in the present disclosure.

FIG. 4A is a diagram illustrating aberration characteristics of the optical imaging system illustrated in FIG. 3A.

FIG. 4B is a diagram illustrating aberration characteristics of the optical imaging system illustrated in FIG. 3B.

FIG. 5A is a diagram illustrating a wide-angle mode of an optical imaging system according to a third embodiment in the present disclosure.

FIG. 5B is a diagram illustrating a telephoto mode of the optical imaging system according to the third embodiment in the present disclosure.

FIG. 6A is a diagram illustrating aberration characteristics of the optical imaging system illustrated in FIG. 5A.

FIG. 6B is a diagram illustrating aberration characteristics of the optical imaging system illustrated in FIG. 5B.

FIG. 7A is a diagram illustrating a wide-angle mode of an optical imaging system according to a fourth embodiment in the present disclosure.

FIG. 7B is a diagram illustrating a telephoto mode of the optical imaging system according to the fourth embodiment in the present disclosure.

FIG. 8A is a diagram illustrating aberration characteristics of the optical imaging system illustrated in FIG. 7A.

FIG. 8B is a diagram illustrating aberration characteristics of the optical imaging system illustrated in FIG. 7B.

FIG. 9A is a diagram illustrating a wide-angle mode of an optical imaging system according to a fifth embodiment in the present disclosure.

FIG. 9B is a diagram illustrating a telephoto mode of the optical imaging system according to the fifth embodiment in the present disclosure.

FIG. 10A is a diagram illustrating aberration characteristics of the optical imaging system illustrated in FIG. 9A.

FIG. 10B is a diagram illustrating aberration characteristics of the optical imaging system illustrated in FIG. 9B.

FIG. 11A is a diagram illustrating a wide-angle mode of an optical imaging system according to a sixth embodiment in the present disclosure.

FIG. 11B is a diagram illustrating a telephoto mode of the optical imaging system according to the sixth embodiment in the present disclosure.

FIG. 12A is a diagram illustrating aberration characteristics of the optical imaging system illustrated in FIG. 11A.

FIG. 12B is a diagram illustrating aberration characteristics of the optical imaging system illustrated in FIG. 11B.

FIG. 13A is a diagram illustrating a wide-angle mode of an optical imaging system according to a seventh embodiment in the present disclosure.

FIG. 13B is a diagram illustrating a telephoto mode of the optical imaging system according to the seventh embodiment in the present disclosure.

FIG. 14A is a diagram illustrating aberration characteristics of the optical imaging system illustrated in FIG. 13A.

FIG. 14B is a diagram illustrating aberration characteristics of the optical imaging system illustrated in FIG. 13B.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

In the lens configuration diagrams in the drawings, the thickness, size, and shape of a lens may be somewhat exaggerated for clarity of illustration, and in particular, the spherical or aspherical shape of a lens shown in the lens configuration diagrams is only an example, and is not limited thereto.

An optical imaging system according to an embodiment in the present disclosure may be mounted in a portable electronic device. For example, the optical imaging system may be a component of a camera module mounted in a portable electronic device. The portable electronic device may be, for example, a mobile communication terminal, a smartphone, a tablet PC, or other portable electronic device.

In the present embodiment, a first lens (or a frontmost lens) refers to a lens closest to an object side of an optical imaging system, and a last lens (or a rearmost lens) refers to a lens closest to an imaging plane (or an image sensor) of the optical imaging system.

In addition, in each lens, an object-side surface refers to a surface of the lens closest to the object side of the optical imaging system, and an image-side surface refers to a surface of the lens closest to the image side of the optical imaging system.

In addition, in this specification, values of a radius of curvature of a lens, a thickness of a lens, a distance between lenses, a focal length of a lens, and various other distances are all expressed in mm, and a field of view (FOV) of an optical imaging system is expressed in degrees.

In addition, in a description of a shape of a lens, a statement that a surface of the lens is convex means that a paraxial region of the surface is convex, and a statement that a surface of the lens is concave means that a paraxial region of the surface is concave.

Therefore, even when it is stated that a surface of a lens is convex, an edge portion of the surface may be concave. Similarly, even when it is stated that a surface of a lens is concave, an edge portion of the lens may be convex.

A paraxial region of a lens surface is a very narrow region of the lens surface near an optical axis of the lens surface.

In greater detail, a paraxial region of a lens surface is a central portion of the lens surface surrounding and including the optical axis of the lens surface in which light rays incident to the lens surface make a small angle θ to the optical axis, and the approximations sin θ≈θ, tan θ≈θ, and cos θ≈1 are valid.

An imaging plane may refer to a virtual surface on which a focus is formed by the optical imaging system. Alternatively, the imaging plane may refer to one surface of an image sensor on which light is received through the optical imaging system.

An optical imaging system according to an embodiment in the present disclosure includes a plurality of lens groups. For example, the optical imaging system may include a first lens group, a second lens group, a third lens group, and a fourth lens group sequentially arranged in ascending numerical order along an optical axis of the optical imaging system from an object side of the optical imaging system toward an imaging plane of the optical imaging system.

Each of the first lens group to the fourth lens group includes a plurality of lenses. For example, the optical imaging system includes at least eight lenses.

The plurality of lenses may be spaced apart from each other along the optical axis by a predetermined distances. Some of these distances may change as the focal length of the optical imaging system is changed between a wide-angle mode and a telephoto mode.

In an embodiment, the optical imaging system includes a first lens, a second lens, a third lens, a fourth lens, a fifth lens, a sixth lens, a seventh lens, and an eighth lens sequentially arranged in ascending numerical order along an optical axis of the optical imaging system from the object side of the optical imaging system toward the imaging plane of the optical imaging system.

The optical imaging system according to an embodiment in the present disclosure may further include a reflective member having a reflective surface changing an optical path. For example, the reflective member may be a mirror or a prism.

By changing the optical path through the reflective member, the optical path may be elongated in a relatively narrow space.

Therefore, the optical imaging system may be miniaturized while allowing the optical imaging system to have a long focal length.

In addition, the optical imaging system may further include an image sensor for converting an incident image of a subject into an electric signal.

In addition, the optical imaging system may further include an infrared cut filter (hereinafter referred to as a filter) for blocking infrared rays. The filter may be disposed between the rearmost lens and the image sensor.

In addition, the optical imaging system may further include a stop disposed between the second lens group and the third lens group. In an embodiment, the stop may be disposed between the fifth lens and the sixth lens, and may be aligned with an object-side surface of the sixth lens.

In an embodiment, the first lens group may include a first lens and a second lens, the second lens group may include a third lens, a fourth lens, and a fifth lens, the third lens group may include a sixth lens and a seventh lens, and a fourth lens group may include an eighth lens.

A reflective member may be disposed between the first lens group and the second lens group. That is, the reflective member may be disposed between the second lens and the third lens.

At least one lens group among the first lens group to the fourth lens group may be moved to change a overall focal length of the optical imaging system.

For example, a gap between the first lens group and the second lens group may vary. For example, the first lens group may be fixedly disposed and the second lens group may be disposed to be movable in the optical axis direction.

As the second lens group moves from the object side of the optical imaging system toward the imaging plane of the optical imaging system, the overall focal length of the optical imaging system may be changed. For example, the optical imaging system may be changed from a wide-angle mode to a telephoto mode.

Since the first lens group is located at the frontmost position in the optical imaging system, it is easy to implement waterproofing and dustproofing when the first lens group is fixed.

The first lens group is disposed in front of the reflective member. In addition, the first lens group includes at least one lens having a meniscus shape convex toward the object side, and the first lens group has a positive refractive power as a whole.

In an embodiment, the first lens group may include the first lens and the second lens. A composite focal length of the first lens and the second lens has a positive value.

In addition, the first lens and the second lens may be made of materials having different optical properties. For example, one of the first lens and the second lens may be made of a material having a low Abbe number, and the other one of the first lens and the second lens may be made of a material having a high Abbe number. Therefore, the chromatic aberration correction capability of the optical imaging system may be improved.

In an embodiment, the Abbe number of one of the first lens and the second lens may be 50 or more, and the Abbe number of the other one of the first lens and the second lens may be 25 or less.

In an embodiment, the Abbe number of a lens having a positive refractive power among the first lens and the second lens may be 50 or more, and the Abbe number of a lens having a negative refractive power among the first lens and the second lens may be 25 or less.

The first lens may have a meniscus shape convex toward the object side.

The second lens group includes a plurality of lenses and has a negative refractive power as a whole.

In an embodiment, the second lens group includes the third lens, the fourth lens, and the fifth lens. Any one of the third to fifth lenses may have a biconcave shape.

For example, the third lens may have a biconcave shape, and the fourth lens may have a meniscus shape convex toward the object side.

The third lens group includes a plurality of lenses and has a positive refractive power as a whole. In addition, the stop may be disposed in front of the third lens group.

Among the plurality of lenses included in the third lens group, the lens disposed closest to the stop (for example, the lens located immediately behind the stop) has a positive refractive power.

A composite focal length of the first lens group and the second lens group may have a negative value. That is, since light passing through the first lens group and the second lens group diverges, the lens disposed to be closest to the stop among the lenses included in the third lens group may have a positive refractive power, thereby reducing the diameter of the lenses arranged therebehind.

In an embodiment, the third lens group includes the sixth lens and the seventh lens.

The sixth lens may have a biconvex shape, and may have a positive refractive power. The seventh lens may have a meniscus shape convex toward the object side, and may have a negative refractive power.

The third lens group may be a lens group fixedly disposed without moving.

The fourth lens group includes at least one lens and has a positive refractive power overall.

In an embodiment, the fourth lens group includes an eighth lens, and the eighth lens may have a positive refractive power.

At least one of the first to fourth lens groups may be moved to correct a focal position according to a change in the overall focal length of the optical imaging system.

For example, the fourth lens group may be disposed to be movable in the optical axis direction. As the fourth lens group is moved, a gap between the third lens group and the fourth lens group and a gap between the fourth lens group and the image sensor may vary.

When the overall focal length of the optical imaging system is changed from a wide-angle mode to a telephoto mode, the fourth lens group may be moved along the optical axis to correct a focal position.

That is, the second lens group may be moved along the optical axis to change the overall focal length of the optical imaging system (optical zoom function), and as the overall focal length of the optical imaging system is changed, the fourth lens group may be moved along the optical axis to correct a focus position.

Therefore, the optical imaging system according to an embodiment in the present disclosure has an optical zoom function.

At least one lens among the lenses included in each lens group has an aspherical surface defined by Equation 1 below.

$$Equation 1$$

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} + {EY}^{12} + {FY}^{14} + {GY}^{16} + {HY}^{18} + {JY}^{20} + {LY}^{22} + {MY}^{24} + {NY}^{26} + {OY}^{28} + {PY}^{30} …$$

In Equation 1, c is a curvature of the lens surface and is equal to a reciprocal of a radius of curvature of the lens surface at an optical axis of the lens surface, K is a conic constant, and Y is a distance from any point on the aspherical surface of the lens to the optical axis. In addition, constants A to H, J, and L to P are aspherical surface coefficients. Z (also known as sag) is a distance in a direction parallel to an optical axis direction between the point on the aspherical surface of the lens at the distance Y from the optical axis of the aspherical surface to a tangential plane perpendicular to the optical axis and intersecting a vertex of the aspherical surface.

The optical imaging system according to an embodiment in the present disclosure may satisfy any one or any combination of any two or more of the following Conditional Expressions 1 to 12.

$$0.1 < air\_T12 < 2.5 \qquad ( Conditional Expression 1 )$$

$$0.1 < air\_T45 < 1. \qquad ( Conditional Expression 2 )$$

$$0.1 < n 1 - n 2 < 0.2 \qquad ( Conditional Expression 3 )$$

$$0.08 < n 5 - n 4 < 0.2 \qquad ( Conditional Expression 4 )$$

$$0.1 < fw / f 2 < 2. \qquad ( Conditional Expression 5 )$$

$$0.1 < fw / f 5 < 2. \qquad ( Conditional Expression 6 )$$

$$- 0.9 < L8Sag\_ 1 - L8Sag\_ 1 / 2 < - 0.01 \qquad ( Conditional Expression 7 )$$

$$0.4 < DS / TTL < 0.65 \qquad ( Conditional Expression 8 )$$

$$0.45 < DS / fG 1 < 1. \qquad ( Conditional Expression 9 )$$

$$0.6 < fc / fG 2 < 1. \qquad ( Conditional Expression 10 )$$

$$- 3.5 < fG 1 / fG 2 < - 2 \qquad ( Conditional Expression 11 )$$

$$- 0.6 < fG 2 / fG 3 < - 0.2 \qquad ( Conditional Expression 12 )$$

In an embodiment, the optical imaging system may satisfy 0.1<air_T12<2.5 (Conditional Expression 1), where air_T12 is a distance along the optical axis from the image-side surface of the first lens to the object-side surface of the second lens.

By arranging the first lens and the second lens to be spaced apart from each other along the optical axis by a distance that satisfies Conditional Expression 1, the degree of freedom of the curvature radius of each lens surface may be increased, which is advantageous in securing the performance of the optical imaging system.

In an embodiment, the optical imaging system may satisfy 0.1<air_T45<1.0 (Conditional Expression 2), where air_T45 is a distance along the optical axis from the image-side surface of the fourth lens to the object-side surface of the fifth lens.

By arranging the fourth lens and the fifth lens to be spaced apart from each other along the optical axis by a distance that satisfies Conditional Expression 2, the degree of freedom of the curvature radius of each lens surface may be increased, which is advantageous in securing the performance of the optical imaging system.

In an embodiment, the optical imaging system may satisfy 0.1<n1−n2<0.2 (Conditional Expression 3), where n1 is a refractive index of the first lens, and n2 is a refractive index of the second lens.

By satisfying Conditional Expression 3, the chromatic aberration correction performance may be improved.

In an embodiment, the optical imaging system may satisfy 08<n5−n4<0.2 (Conditional Expression 4), where n4 is a refractive index of the fourth lens, and n5 is a refractive index of the fifth lens.

By satisfying Conditional Expression 4, the chromatic aberration correction performance may be improved.

In an embodiment, the optical imaging system may satisfy 0.1<fw/f2<2.0 (Conditional Expression 5), where fw is a total focal length of the optical imaging system in the wide-angle mode, and f2 is a focal length of the second lens.

The resolution may be improved by appropriately adjusting the focal length of the second lens to satisfy Conditional Expression 5.

In an embodiment, the optical imaging system may satisfy 0.1<fw/f5<2.0 (Conditional Expression 6), where f5 is a focal length of the fifth lens.

The resolution may be improved by appropriately adjusting the focal length of the fifth lens to satisfy Conditional Expression 6.

In an embodiment, the optical imaging system may satisfy −0.9<L8Sag_1−L8Sag_1/2<−0.01 (Conditional Expression 7), where L8Sag_1 is a sag value of the object-side surface of the eighth lens at an effective diameter of the object-side surface of the eighth lens, and L8Sag_1/2 is a sag value of the object-side surface of the eighth lens at one half of the effective diameter of the object-side surface of the eighth lens. L8Sag_1 and L8Sag_1/2 may be calculated using Equation 1 above.

Therefore, the object-side surface of the eighth lens may have an inflection point, thereby improving the resolution.

In an embodiment, the optical imaging system may satisfy 0.4<DS/TTL<0.65 (Conditional Expression 8), where DS is a distance along the optical axis from the object-side surface of the first lens group to the stop, and TTL is a distance along the optical axis from the object-side surface of the first lens group to the imaging plane.

The diameter of the stop may be reduced as the distance of the stop from the first lens group increases, which helps reduce the thickness of the optical imaging system (or the thickness of a portable electronic device in which the optical imaging system is disposed). However, if the stop is too far from the first lens group, there is a problem that a total track length (TTL) of the optical imaging system increases.

In addition, if the stop is positioned too close to the first lens group, there is a problem that the diameter of the stop becomes too large. The increase in the diameter of the stop may increase the thickness of the optical imaging system, but since the thickness of the optical imaging system is dependent on the thickness of the portable electronic device, there is a limit to increasing the diameter of the stop.

Therefore, the optical imaging system may have an appropriate thickness and TTL by satisfying Conditional Expression 8).

In an embodiment, the optical imaging system may satisfy 0.45<DS/fG1<1.0 (Conditional Expression 9), where fG1 is a focal length of the first lens group.

Conditional Expression 9 represents a relationship between the focal length of the first lens group and the position of the stop. Since the optical imaging system satisfies the condition 0.45<DS/fG1<1.0, the first lens group has an appropriate level of refractive power, while the optical imaging system may have an appropriate level of Fno, which is an f-number of the optical imaging system.

In an embodiment, the optical imaging system may satisfy 0.6<fc/fG2<1.0 (Conditional Expression 10), where fc is a focal length of a biconcave lens included in the second lens group, and fG2 is a focal length of the second lens group.

The second lens group acts as a variator responsible for a change in the FOV (or a change in the overall focal length) of the optical imaging system, so it is necessary to minimize a change in aberration due to the movement of the second lens group. The second lens group includes a biconcave lens, and the biconcave lens may have a significant effect on optical characteristics of the second lens group. Therefore, the optical imaging system may minimize the change in aberration due to the movement of the second lens group by satisfying Conditional Expression 10 so that the second lens group has an appropriate level of refractive power while playing the role of a variator.

In an embodiment, the optical imaging system may satisfy −3.5<fG1/fG2<−2 (Conditional Expression 11).

By satisfying Conditional Expression 11, the focal lengths of the first lens group and the second lens group may be appropriately adjusted to minimize the occurrence of aberration.

In an embodiment, the optical imaging system may satisfy −0.6<fG2/fG3<−0.2 (Conditional Expression 12), where fG3 is a focal length of the third lens group.

By satisfying Conditional Expression 12, the focal lengths of the second lens group and the third lens group may be appropriately adjusted to minimize the occurrence of aberration.

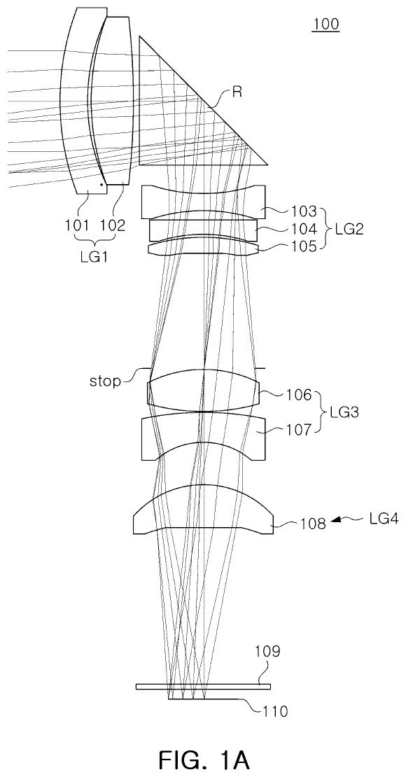

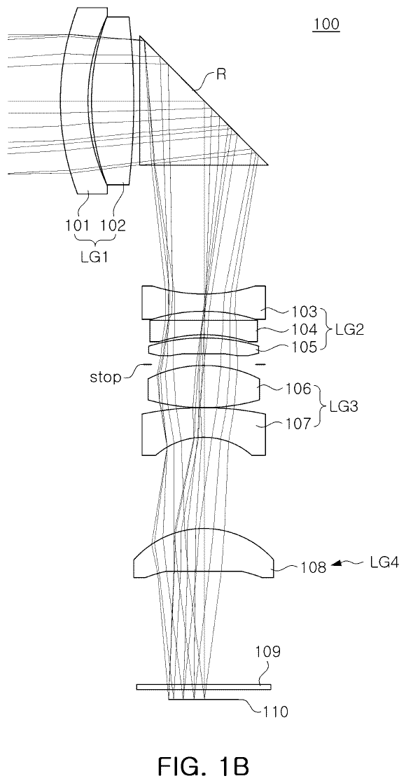

FIG. 1A is a diagram illustrating a wide-angle mode of an optical imaging system according to a first embodiment in the present disclosure, and FIG. 1B is a diagram illustrating a telephoto mode of the optical imaging system according to the first embodiment in the present disclosure.

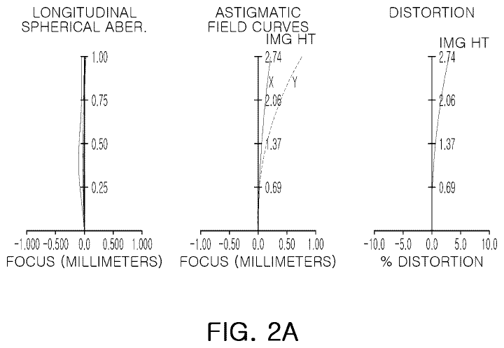

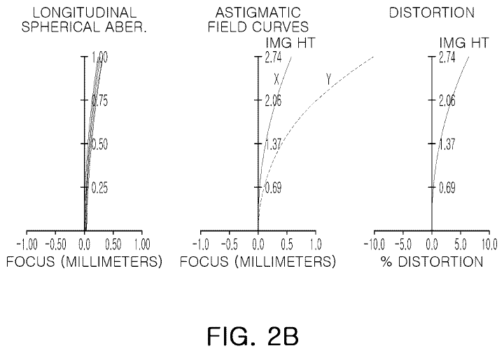

In addition, FIG. 2A is a diagram illustrating aberration characteristics of the wide-angle mode of the optical imaging system illustrated in FIG. 1A, and FIG. 2B is a diagram illustrating aberration characteristics of the telephoto mode of the optical imaging system illustrated in FIG. 1B.

The optical imaging system according to the first embodiment in the present disclosure includes a first lens group LG1, a second lens group LG2, a third lens group LG3, and a fourth lens group LG4.

In order from the object side of the optical imaging system, the first lens group LG1 includes a first lens 101 and a second lens 102, the second lens group LG2 includes a third lens 103, a fourth lens 104, and a fifth lens 105, the third lens group LG3 includes a sixth lens 106 and a seventh lens 107, and the fourth lens group LG4 includes an eighth lens 108.

In addition, the optical imaging system further includes a reflective member R disposed between the first lens group LG1 and the second lens group LG2, and a stop disposed between the second lens group LG2 and the third lens group LG3. The stop is aligned with an object-side surface of the third lens group LG3.

In addition, the optical imaging system may further include a filter 109 and an image sensor. The image sensor may include an imaging plane 110. The imaging plane 110 may refer to a surface on which a focus is formed by the optical imaging system.

The characteristics of each lens (a radius of curvature of each lens surface, a thickness of each lens or a distance between lenses, a refractive index of each lens, and an Abbe number of each lens) are illustrated in Table 1 below.

TABLE 1

| Surface | | Radius of | Thickness/ | Refractive | Abbe | |
|---|---|---|---|---|---|---|
| No. | Element | Curvature | Distance | Index | Number | Comment |
| S1 | First | 12.233 | 1.274 | 1.66 | 20.4 | First |
| S2 | Lens | 9.242 | 0.159 | | | Lens Group |
| S3 | Second | 10.995 | 2.030 | 1.535 | 56 | |
| S4 | Lens | −32.194 | 0.300 | | | |
| S5 | Reflective | Infinity | 3.000 | 1.717 | 29.5 | Reflective |
| S6 | Member | Infinity | 3.000 | 1.717 | 29.5 | Member |
| S7 | | Infinity | D1 | | | |
| S8 | Third | −7.939 | 0.816 | 1.544 | 56 | Second |
| S9 | Lens | 6.321 | 0.427 | | | Lens Group |
| S10 | Fourth | 30.694 | 0.721 | 1.544 | 56 | |
| S11 | Lens | 20.708 | 0.166 | | | |
| S12 | Fifth | 13.335 | 0.748 | 1.635 | 23.9 | |
| S13 | Lens | 22.554 | D2 | | | |
| S14 | Stop | Infinity | 0.000 | | | Stop |
| S15 | Sixth | 4.717 | 2.000 | 1.567 | 55.6 | Third |
| S16 | Lens | −29.201 | 0.056 | | | Lens Group |
| S17 | Seventh | 6.433 | 1.381 | 1.635 | 23.9 | |
| S18 | Lens | 2.760 | D3 | | | |
| S19 | Eighth | 5.245 | 1.997 | 1.535 | 56 | Fourth |
| S20 | Lens | 281.841 | D4 | | | Lens Group |
| S21 | Filter | Infinity | 0.210 | 1.516 | 64.1 | Filter |
| S22 | | Infinity | 0.461 | | | |
| S23 | Imaging Plane | Infinity | | | | Imaging Plane |

TABLE 2

| | Wide-Angle | Telephoto |
|---|---|---|
| Distance | Mode | Mode |
| D1 | 1.332 | 6.050 |
| D2 | 5.454 | 0.735 |
| D3 | 2.042 | 4.329 |
| D4 | 7.428 | 5.141 |

In Table 2 above, D1 is a distance along the optical axis between the reflective member R and the third lens 103, D2 is a distance along the optical axis between the fifth lens 105 and the sixth lens 106 (or the stop), D3 is a distance along the optical axis between the seventh lens 107 and the eighth lens 108, and D4 is a distance along the optical axis between the eighth lens 108 and the filter 109.

A focal length fG1 of the first lens group LG1 is 21.047 mm, a focal length fG2 of the second lens group LG2 is −6.803 mm, a focal length fG3 of the third lens group LG3 is 14.474 mm, and a focal length fG4 of the fourth lens group LG4 is 9.936 mm.

In the first embodiment in the present disclosure, the first lens group LG1 has a positive refractive power overall, the second lens group LG2 has a negative refractive power overall, the third lens group LG3 has a positive refractive power overall, and the fourth lens group LG4 has a positive refractive power overall.

The first lens 101 has a negative refractive power, the object-side surface of the first lens 101 is convex, and the image-side surface of the first lens 101 is concave.

The second lens 102 has a positive refractive power, and the object-side surface and the image-side surface of the second lens 102 are convex.

The reflective member R is disposed behind the second lens 102.

The third lens 103 has a negative refractive power, and the object-side surface and the image-side surface of the third lens 103 are concave.

The fourth lens 104 has a negative refractive power, the object-side surface of the fourth lens 104 is convex, and the image-side surface of the fourth lens 104 is concave.

The fifth lens 105 has a positive refractive power, the object-side surface of the fifth lens 105 is convex, and the image-side surface of the fifth lens 105 is concave.

The sixth lens 106 has a positive refractive power, and the object-side surface and the image-side surface of the sixth lens 106 are convex. The stop is disposed in front of the sixth lens 106, and is aligned with the object-side surface of the sixth lens 106. That is, a distance along the optical axis between the stop and the object-side surface of the sixth lens 106 is 0.

The seventh lens 107 has a negative refractive power, the object-side surface of the seventh lens 107 is convex, and the image-side surface of the seventh lens 107 is concave. The eighth lens 108 has a positive refractive power, the object-side surface of the eighth lens 108 is convex, and the image-side surface of the eighth lens 108 is concave.

Each surface of the first lens 101 to the eighth lens 108 has the aspherical coefficients illustrated in Table 3 below. That is, each surface of the first lens 101 to the eighth lens 108 is aspherical.

TABLE 3

| Surface | | | | | | | | |
|---|---|---|---|---|---|---|---|---|
| No. | S1 | S2 | S3 | S4 | S8 | S9 | S10 | S11 |
| K | 5.084E−01 | −6.277E−02 | −3.436E+00 | −1.267E+01 | −6.843E+00 | 8.744E−01 | −3.264E+01 | 6.835E+01 |
| A | −1.552E−01 | −6.163E−02 | 4.451E−01 | 1.015E−01 | 1.807E−01 | −8.961E−02 | −2.993E−02 | 1.896E−01 |
| B | 3.242E−03 | 4.176E−03 | 1.177E−02 | 1.364E−02 | −2.238E−02 | −2.019E−02 | −4.342E−02 | −1.813E−01 |
| C | 1.095E−02 | 2.361E−02 | 8.172E−03 | −4.893E−03 | 1.566E−03 | −1.042E−02 | 1.190E−03 | 4.643E−02 |
| D | −2.819E−03 | −2.288E−03 | −1.955E−03 | −4.156E−04 | 6.874E−03 | −3.274E−03 | −1.565E−02 | −1.834E−02 |
| E | 1.344E−03 | 3.134E−03 | 9.650E−05 | −8.680E−04 | 4.256E−04 | 3.091E−03 | 4.512E−03 | 1.038E−02 |
| F | −6.340E−04 | −4.044E−04 | −3.067E−04 | −2.780E−06 | −2.995E−04 | −8.376E−03 | −6.548E−03 | −9.625E−03 |
| G | 3.004E−04 | 5.063E−04 | −2.022E−04 | −1.566E−04 | 1.182E−03 | −1.739E−03 | −1.454E−03 | 3.614E−03 |
| H | −1.553E−04 | −1.572E−04 | −9.468E−05 | −9.808E−06 | 6.457E−04 | −1.086E−03 | −3.282E−03 | −6.894E−04 |
| J | 8.545E−05 | 2.055E−04 | 1.077E−04 | −1.534E−05 | 5.170E−04 | 1.794E−03 | −1.595E−03 | 2.208E−03 |
| L | −4.713E−05 | −4.652E−05 | 0.000E+00 | 2.298E−06 | −6.638E−04 | 1.300E−03 | −1.098E−03 | −8.145E−04 |
| M | 2.178E−05 | 2.144E−05 | 0.000E+00 | 3.029E−07 | 6.194E−04 | 7.970E−04 | −6.559E−04 | −2.316E−05 |
| N | −5.288E−06 | −1.092E−05 | 0.000E+00 | −2.546E−06 | 4.070E−04 | 2.985E−04 | −2.707E−04 | 2.901E−04 |
| O | 5.481E−07 | −9.409E−06 | 0.000E+00 | 6.979E−06 | 2.534E−04 | 1.855E−05 | −1.230E−04 | 3.552E−04 |
| P | −2.286E−07 | −7.495E−07 | 0.000E+00 | −2.764E−06 | −1.298E−04 | −8.384E−06 | −3.743E−05 | 3.057E−04 |

| Surface | | | | | | | | |
|---|---|---|---|---|---|---|---|---|
| No | S12 | S13 | S15 | S16 | S17 | S18 | S19 | S20 |
| K | 2.468E+01 | −8.978E+01 | −1.322E+00 | 9.692E+01 | −4.502E+01 | −8.987E−01 | 6.731E−01 | 1.274E−10 |
| A | −1.116E−01 | −2.252E−01 | −1.942E−01 | −2.961E−01 | −4.826E−02 | −1.055E−01 | 1.207E−01 | 4.717E−01 |
| B | −7.818E−02 | −1.039E−02 | −9.999E−03 | 1.119E−01 | 4.465E−02 | 1.758E−02 | 4.492E−02 | 8.293E−02 |
| C | 7.102E−02 | 1.193E−02 | 2.697E−02 | −2.855E−02 | −3.231E−02 | −1.935E−03 | 1.076E−02 | −4.705E−04 |
| D | −1.158E−02 | −3.551E−05 | −1.224E−02 | 1.897E−02 | 3.252E−03 | 1.930E−04 | 1.159E−03 | −1.947E−02 |
| E | −3.375E−03 | −5.888E−05 | −1.906E−02 | −1.833E−02 | −7.131E−03 | −7.104E−04 | −9.224E−04 | −1.482E−02 |
| F | −9.785E−03 | 6.423E−04 | 4.736E−04 | 2.103E−03 | 9.756E−03 | −3.460E−04 | −8.018E−04 | −4.721E−03 |
| G | 3.774E−03 | 9.119E−04 | 8.328E−03 | −3.722E−03 | −4.424E−03 | −3.798E−04 | −3.477E−04 | 2.700E−03 |
| H | 2.230E−03 | 4.321E−04 | 1.749E−03 | 5.445E−03 | −1.179E−03 | −2.221E−04 | −8.672E−05 | 5.097E−03 |
| J | 1.519E−03 | −1.803E−04 | −4.332E−03 | 2.584E−03 | −3.291E−03 | −1.415E−04 | −8.407E−05 | 3.983E−03 |
| L | −1.766E−03 | −5.100E−04 | −2.918E−03 | 3.925E−03 | 2.255E−03 | −7.583E−05 | −1.570E−04 | 1.796E−03 |
| M | 7.276E−05 | −6.754E−05 | 9.396E−04 | 1.446E−03 | 2.041E−03 | −2.243E−05 | −1.620E−04 | 2.523E−04 |
| N | 1.133E−03 | 2.282E−04 | 2.298E−03 | 1.096E−03 | 2.187E−03 | −1.940E−05 | −1.024E−04 | −3.017E−04 |
| O | 1.154E−03 | 2.486E−04 | 1.321E−03 | 2.946E−04 | 5.171E−04 | 2.623E−06 | −2.902E−05 | −2.374E−04 |
| P | 5.227E−04 | 1.018E−04 | 2.809E−04 | 1.224E−04 | 1.372E−04 | 6.500E−07 | −8.086E−07 | −7.367E−05 |

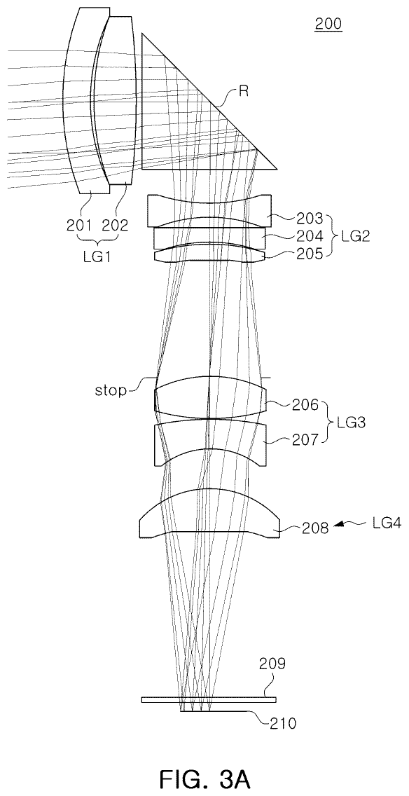

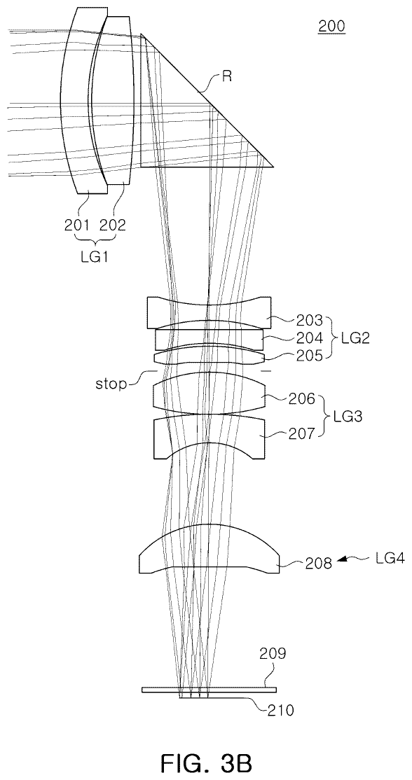

FIG. 3A is a diagram illustrating a wide-angle mode of an optical imaging system according to a second embodiment in the present disclosure, and FIG. 3B is a diagram illustrating a telephoto mode of the optical imaging system according to the second embodiment in the present disclosure.

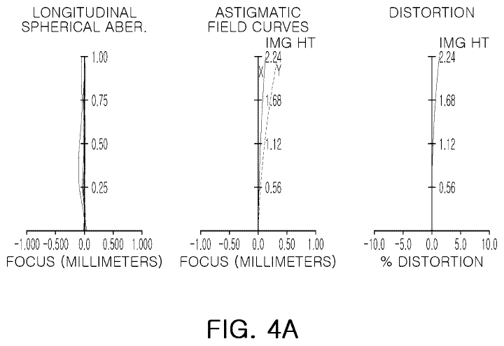

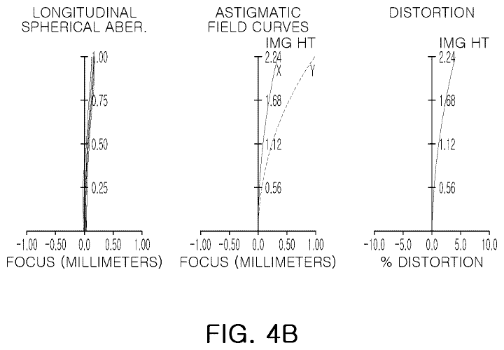

In addition, FIG. 4A is a diagram illustrating aberration characteristics of the wide-angle mode of the optical imaging system illustrated in FIG. 3A, and FIG. 4B is a diagram illustrating aberration characteristics of the telephoto mode of the optical imaging system illustrated in FIG. 3B.

The optical imaging system according to the second embodiment in the present disclosure includes a first lens group LG1, a second lens group LG2, a third lens group LG3, and a fourth lens group LG4.

In order from the object side of the optical imaging system, the first lens group LG1 includes a first lens 201 and a second lens 202, the second lens group LG2 includes a third lens 203, a fourth lens 204, and a fifth lens 205, the third lens group LG3 includes a sixth lens 206 and a seventh lens 207, and the fourth lens group LG4 includes an eighth lens 208.

In addition, the optical imaging system further includes a reflective member R disposed between the first lens group LG1 and the second lens group LG2, and a stop disposed between the second lens group LG2 and the third lens group LG3. The stop is aligned with an object-side surface of the third lens group LG3.

In addition, the optical imaging system may further include a filter 209 and an image sensor. The image sensor may include an imaging plane 210. The imaging plane 210 may refer to a surface on which a focus is formed by the optical imaging system.

The characteristics of each lens (a radius of curvature of each lens surface, a thickness of each lens or a distance between lenses, a refractive index of each lens, and an Abbe number of each lens) are illustrated in Table 4 below.

TABLE 4

| Surface | | Radius of | Thickness/ | Refractive | Abbe | |
|---|---|---|---|---|---|---|
| No. | Element | Curvature | Distance | Index | Number | Comment |
| S1 | First | 12.178 | 1.214 | 1.66 | 20.4 | First |
| S2 | Lens | 9.222 | 0.160 | | | Lens |
| S3 | Second | 10.997 | 2.006 | 1.535 | 56 | Group |
| S4 | Lens | −35.653 | 0.300 | | | |
| S5 | Reflective | Infinity | 3.000 | 1.717 | 29.5 | Reflective |
| S6 | Member | Infinity | 3.000 | 1.717 | 29.5 | Member |
| S7 | | Infinity | D1 | | | |
| S8 | Third | −7.921 | 0.700 | 1.544 | 56 | Second |
| S9 | Lens | 6.332 | 0.430 | | | Lens |
| S10 | Fourth | 30.996 | 0.700 | 1.544 | 56 | Group |
| S11 | Lens | 20.806 | 0.166 | | | |
| S12 | Fifth | 13.379 | 0.700 | 1.635 | 23.9 | |
| S13 | Lens | 23.704 | D2 | | | |
| S14 | Stop | Infinity | 0.000 | | | Stop |
| S15 | Sixth | 4.717 | 1.943 | 1.567 | 54.4 | |
| S16 | Lens | −29.236 | 0.050 | | | |
| S17 | Seventh | 6.434 | 1.335 | 1.635 | 23.9 | Third |
| S18 | Lens | 2.753 | D3 | | | Lens |
| | | | | | | Group |
| S19 | Eighth | 5.197 | 1.969 | 1.535 | 56 | Fourth |
| S20 | Lens | 173.047 | D4 | | | Lens |
| | | | | | | Group |
| S21 | Filter | Infinity | 0.210 | 1.516 | 64.1 | Filter |
| S22 | | Infinity | 0.479 | | | |
| S23 | Imaging | Infinity | | | | Imaging |
| | Plane | | | | | Plane |

TABLE 5

| | Wide-Angle | Telephoto |
|---|---|---|
| Distance | Mode | Mode |
| D1 | 1.503 | 6.500 |
| D2 | 5.501 | 0.505 |
| D3 | 1.939 | 3.899 |
| D4 | 7.714 | 5.755 |

In Table 5 above, D1 is a distance along the optical axis between the reflective member R and the third lens 203, D2 is a distance along the optical axis between the fifth lens 205 and the sixth lens 206 (or the stop), D3 is a distance along the optical axis between the seventh lens 207 and the eighth lens 208, and D4 is a distance along the optical axis between the eighth lens 208 and the filter 209.

A focal length fG1 of the first lens group LG1 is 21.685 mm, a focal length fG2 of the second lens group LG2 is −6.895 mm, a focal length fG3 of the third lens group LG3 is 14.979 mm, and a focal length fG4 of the fourth lens group LG4 is 9.944 mm.

In the second embodiment in the present disclosure, the first lens group LG1 has a positive refractive power overall, the second lens group LG2 has a negative refractive power overall, the third lens group LG3 has a positive refractive power overall, and the fourth lens group LG4 has a positive refractive power overall.

The first lens 201 has a negative refractive power, the object-side surface of the first lens 201 is convex, and the image-side surface of the first lens 201 is concave.

The second lens 202 has a positive refractive power, and the object-side surface and the image-side surface of the second lens 202 are convex.

The reflective member R is disposed behind the second lens 202.

The third lens 203 has a negative refractive power, and the object-side surface and the image-side surface of the third lens 203 are concave.

The fourth lens 204 has a negative refractive power, the object-side surface of the fourth lens 204 is convex, and the image-side surface of the fourth lens 204 is concave.

The fifth lens 205 has a positive refractive power, the object-side surface of the fifth lens 205 is convex, and the image-side surface of the fifth lens 205 is concave.

The sixth lens 206 has a positive refractive power, and the object-side surface and the image-side surface of the sixth lens 206 are convex. The stop is disposed in front of the sixth lens 206, and is aligned with the object-side surface of the sixth lens 206. That is, a distance along the optical axis between the stop and the object-side surface of the sixth lens 206 is 0.

The seventh lens 207 has a negative refractive power, the object-side surface of the seventh lens 207 is convex, and the image-side surface of the seventh lens 207 is concave.

The eighth lens 208 has a positive refractive power, the object-side surface of the eighth lens 208 is convex, and the image-side surface of the eighth lens 208 is concave.

Each surface of the first lens 201 to the eighth lens 208 has the aspherical coefficients illustrated in Table 6 below. That is, each surface of the first lens 201 to the eighth lens 208 is aspherical.

TABLE 6

| Surface No. | S1 | S2 | S3 | S4 | S8 | S9 | S10 | S11 |
|---|---|---|---|---|---|---|---|---|
| K | 5.055E−01 | −6.141E−02 | −3.451E+00 | −1.304E+01 | −6.806E+00 | 8.527E−01 | −2.899E+01 | 6.851E+01 |
| A | −1.554E−01 | −6.138E−02 | 4.444E−01 | 1.020E−01 | 1.781E−01 | −9.045E−02 | −2.940E−02 | 1.888E−01 |
| B | 3.199E−03 | 4.197E−03 | 1.166E−02 | 1.359E−02 | −2.207E−02 | −1.967E−02 | −4.365E−02 | −1.809E−01 |
| C | 1.109E−02 | 2.353E−02 | 8.121E−03 | −4.826E−03 | 1.817E−03 | −1.048E−02 | 1.172E−03 | 4.651E−02 |
| D | −2.775E−03 | −2.245E−03 | −1.909E−03 | −3.719E−04 | 6.445E−03 | −3.332E−03 | −1.562E−02 | −1.842E−02 |
| E | 1.347E−03 | 3.092E−03 | 1.269E−04 | −9.033E−04 | 6.189E−04 | 3.116E−03 | 4.503E−03 | 1.036E−02 |
| F | −6.382E−04 | −4.158E−04 | −2.341E−04 | 5.237E−05 | −2.878E−04 | −8.400E−03 | −6.494E−03 | −9.631E−03 |
| G | 2.941E−04 | 4.950E−04 | −1.623E−04 | −1.565E−04 | 1.122E−03 | −1.672E−03 | −1.446E−03 | 3.641E−03 |
| H | −1.522E−04 | −1.496E−04 | −9.372E−05 | −9.236E−06 | 6.213E−04 | −1.137E−03 | −3.267E−03 | −6.751E−04 |
| J | 8.320E−05 | 2.164E−04 | 1.232E−04 | −2.261E−05 | 6.420E−04 | 1.799E−03 | −1.649E−03 | 2.192E−03 |
| L | −4.397E−05 | −3.834E−05 | 0.000E+00 | 3.943E−06 | −8.074E−04 | 1.300E−03 | −1.141E−03 | −7.982E−04 |
| M | 2.719E−05 | 2.406E−05 | 0.000E+00 | −1.966E−06 | 6.887E−04 | 8.027E−04 | −6.943E−04 | −4.558E−05 |
| N | −9.991E−06 | −2.004E−05 | 0.000E+00 | 5.828E−06 | 4.127E−04 | 2.961E−04 | −2.738E−04 | 2.669E−04 |
| O | −1.262E−06 | −9.150E−06 | 0.000E+00 | 4.828E−06 | 2.492E−04 | 5.293E−06 | −1.181E−04 | 3.246E−04 |
| P | 2.966E−07 | 6.937E−06 | 0.000E+00 | −6.152E−06 | −2.100E−04 | −1.295E−05 | −3.047E−05 | 3.069E−04 |
| Surface No. | S12 | S13 | S15 | S16 | S17 | S18 | S19 | S20 |
| K | 2.465E+01 | −9.032E+01 | −1.326E+00 | 9.649E+01 | −4.504E+01 | −9.040E−01 | 6.683E−01 | −9.806E+01 |
| A | −1.115E−01 | −2.255E−01 | −1.950E−01 | −2.958E−01 | −4.873E−02 | −1.067E−01 | 1.183E−01 | 4.690E−01 |
| B | −7.816E−02 | −1.047E−02 | −9.652E−03 | 1.120E−01 | 4.490E−02 | 1.702E−02 | 4.655E−02 | 8.514E−02 |
| C | 7.085E−02 | 1.227E−02 | 2.686E−02 | −2.875E−02 | −3.227E−02 | −1.280E−03 | 1.151E−02 | −2.876E−04 |
| D | −1.149E−02 | −1.781E−04 | −1.235E−02 | 1.898E−02 | 3.026E−03 | 2.749E−04 | 9.819E−04 | −1.991E−02 |
| E | −3.358E−03 | −9.576E−05 | −1.892E−02 | −1.832E−02 | −6.950E−03 | −5.786E−04 | −1.060E−03 | −1.493E−02 |
| F | −9.804E−03 | 6.408E−04 | 4.049E−04 | 2.218E−03 | 9.732E−03 | −4.573E−04 | −1.029E−03 | −4.698E−03 |
| G | 3.748E−03 | 9.839E−04 | 8.297E−03 | −3.786E−03 | −4.448E−03 | −4.491E−04 | −3.291E−04 | 2.869E−03 |
| H | 2.239E−03 | 4.251E−04 | 1.784E−03 | 5.394E−03 | −1.223E−03 | −3.160E−04 | −1.440E−05 | 5.156E−03 |
| J | 1.541E−03 | −2.014E−04 | −4.284E−03 | 2.565E−03 | −3.225E−03 | −1.670E−04 | 2.850E−05 | 3.957E−03 |
| L | −1.773E−03 | −5.569E−04 | −2.987E−03 | 3.991E−03 | 2.244E−03 | −6.554E−05 | −1.079E−04 | 1.728E−03 |
| M | 6.535E−05 | −4.290E−05 | 9.076E−04 | 1.462E−03 | 2.029E−03 | 2.712E−05 | −1.864E−04 | 1.939E−04 |
| N | 1.144E−03 | 2.629E−04 | 2.364E−03 | 1.088E−03 | 2.179E−03 | 2.332E−05 | −1.914E−04 | −3.496E−04 |
| O | 1.154E−03 | 2.588E−04 | 1.410E−03 | 2.886E−04 | 5.076E−04 | 3.550E−05 | −1.050E−04 | −2.615E−04 |
| P | 5.404E−04 | 1.041E−04 | 3.070E−04 | 1.202E−04 | 1.018E−04 | 1.074E−05 | −3.433E−05 | −8.392E−05 |

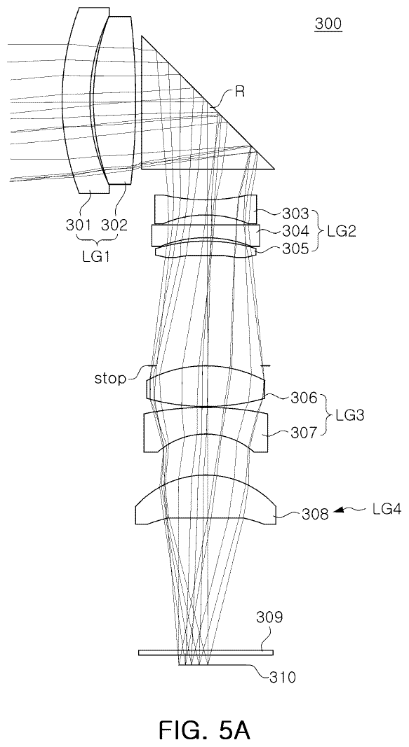

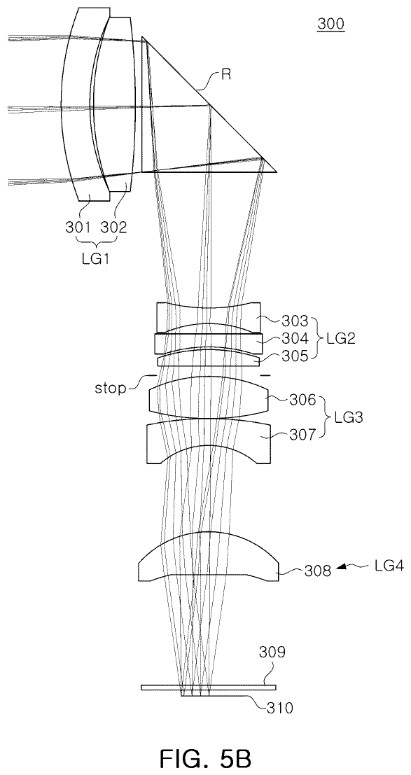

FIG. 5A is a diagram illustrating a wide-angle mode of an optical imaging system according to a third embodiment in the present disclosure, and FIG. 5B is a diagram illustrating a telephoto mode of the optical imaging system according to the third embodiment in the present disclosure.

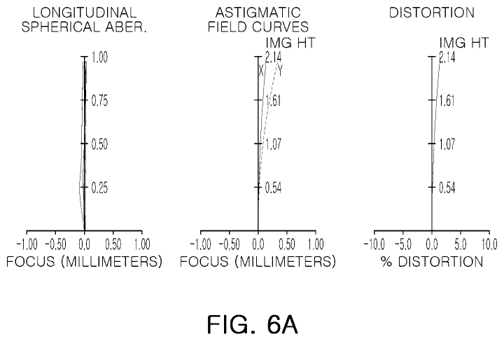

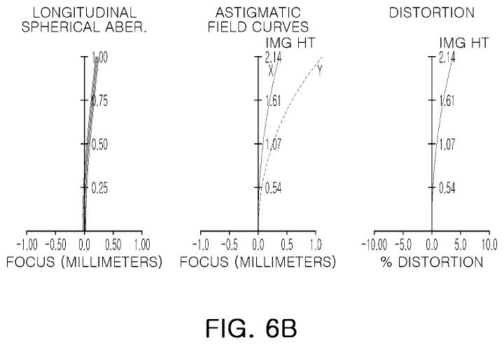

In addition, FIG. 6A is a diagram illustrating aberration characteristics of the wide-angle mode of the optical imaging system illustrated in FIG. 5A, and FIG. 6B is a diagram illustrating aberration characteristics of the telephoto mode of the optical imaging system illustrated in FIG. 5B.

The optical imaging system according to the third embodiment in the present disclosure includes a first lens group LG1, a second lens group LG2, a third lens group LG3, and a fourth lens group LG4.

In order from the object side of the optical imaging system, the first lens group LG1 includes a first lens 301 and a second lens 302, the second lens group LG2 includes a third lens 303, a fourth lens 304, and a fifth lens 305, the third lens group LG3 includes a sixth lens 306 and a seventh lens 307, and the fourth lens group LG4 includes an eighth lens 308.

In addition, the optical imaging system further includes a reflective member R disposed between the first lens group LG1 and the second lens group LG2, and a stop disposed between the second lens group LG2 and the third lens group LG3. The stop is aligned with an object-side surface of the third lens group LG3.

In addition, the optical imaging system may further include a filter 309 and an image sensor. The image sensor may include an imaging plane 310. The imaging plane 310 may refer to a surface on which a focus is formed by the optical imaging system.

The characteristics of each lens (a radius of curvature of each lens surface, a thickness of each lens or a distance between lenses, a refractive index of each lens, and an Abbe number of each lens) are illustrated in Table 7 below.

TABLE 7

| Surface | | Radius of | Thickness/ | Refractive | Abbe | |
|---|---|---|---|---|---|---|
| No. | Element | Curvature | Distance | Index | Number | Comment |
| S1 | First | 12.289 | 1.280 | 1.66 | 20.4 | First |
| S2 | Lens | 9.283 | 0.151 | | | Lens |
| S3 | Second | 10.996 | 2.070 | 1.535 | 56 | Group |
| S4 | Lens | −34.637 | 0.300 | | | |
| S5 | Reflective | Infinity | 3.000 | 1.717 | 29.5 | Reflective |
| S6 | Member | Infinity | 3.000 | 1.717 | 29.5 | Member |
| S7 | | Infinity | D1 | | | |
| S8 | Third | −7.937 | 0.700 | 1.544 | 56 | Second |
| S9 | Lens | 6.330 | 0.411 | | | Lens |
| S10 | Fourth | 30.408 | 0.700 | 1.544 | 56 | Group |
| S11 | Lens | 20.990 | 0.166 | | | |
| S12 | Fifth | 13.471 | 0.700 | 1.635 | 23.9 | |
| S13 | Lens | 22.534 | D2 | | | |
| S14 | Stop | Infinity | 0.000 | | | Stop |
| S15 | Sixth | 4.717 | 2.000 | 1.569 | 54.4 | Third |
| S16 | Lens | −29.264 | 0.050 | | | Lens |
| S17 | Seventh | 6.429 | 1.312 | 1.635 | 23.9 | Group |
| S18 | Lens | 2.764 | D3 | | | |
| S19 | Eighth | 5.247 | 2.000 | 1.535 | 56 | Fourth |
| S20 | Lens | −766.614 | D4 | | | Lens |
| | | | | | | Group |
| S21 | Filter | Infinity | 0.210 | 1.516 | 64.1 | Filter |
| S22 | | Infinity | 0.461 | | | |
| S23 | Imaging | Infinity | | | | Imaging |
| | Plane | | | | | Plane |

TABLE 8

| | Wide-Angle | Telephoto |
|---|---|---|
| Distance | Mode | Mode |
| D1 | 1.620 | 6.500 |
| D2 | 5.380 | 0.500 |
| D3 | 2.062 | 4.133 |
| D4 | 7.428 | 5.357 |

In Table 8 above, D1 is a distance along the optical axis between the reflective member R and the third lens 303, D2 is a distance along the optical axis between the fifth lens 305 and the sixth lens 306 (or the stop), D3 is a distance along the optical axis between the seventh lens 307 and the eighth lens 308, and D4 is a distance along the optical axis between the eighth lens 308 and the filter 309.

The focal length fG1 of the first lens group LG1 is 21.520 mm, the focal length fG2 of the second lens group LG2 is −6.829 mm, the focal length fG3 of the third lens group LG3 is 14.774 mm, and the focal length fG4 of the fourth lens group LG4 is 9.720 mm.

In the third embodiment in the present disclosure, the first lens group LG1 has a positive refractive power overall, the second lens group LG2 has a negative refractive power overall, the third lens group LG3 has a positive refractive power overall, and the fourth lens group LG4 has a positive refractive power overall.

The first lens 301 has a negative refractive power, the object-side surface of the first lens 301 is convex, and the image-side surface of the first lens 301 is concave.

The second lens 302 has a positive refractive power, and the object-side surface and the image-side surface of the second lens 302 are convex.

The reflective member R is disposed behind the second lens 302.

The third lens 303 has a negative refractive power, and the object-side surface and the image-side surface of the third lens 303 are concave.

The fourth lens 304 has a negative refractive power, the object-side surface of the fourth lens 304 is convex, and the image-side surface of the fourth lens 304 is concave.

The fifth lens 305 has a positive refractive power, the object-side surface of the fifth lens 305 is convex, and the image-side surface of the fifth lens 305 is concave.

The sixth lens 306 has a positive refractive power, and the object-side surface and the image-side surface of the sixth lens 306 are convex. The stop is disposed in front of the sixth lens 306, and is aligned with the object-side surface of the sixth lens 306. That is, a distance along the optical axis between the stop and the object-side surface of the sixth lens 306 is 0.

The seventh lens 307 has a negative refractive power, the object-side surface of the seventh lens 307 is convex, and the image-side surface of the seventh lens 307 is concave.

The eighth lens 308 has a positive refractive power, and the object-side surface and the image-side surface of the eighth lens 308 are convex.

Each surface of the first lens 301 to the eighth lens 308 has the aspherical coefficients illustrated in Table 9 below. That is, each surface of the first lens 301 to the eighth lens 308 is aspherical.

TABLE 9

| Surface No. | S1 | S2 | S3 | S4 | S8 | S9 | S10 | S11 |
|---|---|---|---|---|---|---|---|---|
| K | 5.055E−01 | −6.296E−02 | −3.456E+00 | −1.317E+01 | −6.816E+00 | 8.451E−01 | −2.812E+01 | 6.897E+01 |
| A | −1.554E−01 | −6.164E−02 | 4.442E−01 | 1.022E−01 | 1.787E−01 | −9.071E−02 | −2.926E−02 | 1.889E−01 |
| B | 3.014E−03 | 4.164E−03 | 1.194E−02 | 1.343E−02 | −2.217E−02 | −1.965E−02 | −4.366E−02 | −1.808E−01 |
| C | 1.095E−02 | 2.356E−02 | 8.006E−03 | −5.065E−03 | 1.748E−03 | −1.045E−02 | 1.202E−03 | 4.641E−02 |
| D | −2.781E−03 | −2.207E−03 | −1.767E−03 | −3.718E−04 | 6.592E−03 | −3.314E−03 | −1.566E−02 | −1.837E−02 |
| E | 1.345E−03 | 3.063E−03 | 4.806E−05 | −8.815E−04 | 5.474E−04 | 3.070E−03 | 4.515E−03 | 1.031E−02 |
| F | −6.350E−04 | −3.980E−04 | −2.235E−04 | 2.919E−05 | −2.773E−04 | −8.373E−03 | −6.526E−03 | −9.645E−03 |
| G | 3.028E−04 | 5.115E−04 | −1.938E−04 | −1.649E−04 | 1.108E−03 | −1.680E−03 | −1.406E−03 | 3.687E−03 |
| H | −1.524E−04 | −1.598E−04 | −8.448E−05 | −1.208E−06 | 6.894E−04 | −1.119E−03 | −3.212E−03 | −6.839E−04 |
| J | 8.531E−05 | 2.284E−04 | 1.308E−04 | −1.875E−05 | 5.496E−04 | 1.760E−03 | −1.693E−03 | 2.211E−03 |
| L | −4.719E−05 | −4.416E−05 | 0.000E+00 | 6.010E−06 | −7.606E−04 | 1.341E−03 | −1.163E−03 | −7.988E−04 |
| M | 2.148E−05 | 3.049E−05 | 0.000E+00 | −3.642E−06 | 6.999E−04 | 7.912E−04 | −7.383E−04 | −1.042E−04 |
| N | −5.790E−06 | −7.576E−06 | 0.000E+00 | −1.184E−06 | 4.091E−04 | 2.808E−04 | −2.884E−04 | 2.646E−04 |
| O | 1.801E−07 | −5.049E−06 | 0.000E+00 | 4.559E−06 | 2.048E−04 | −7.801E−06 | −1.551E−04 | 3.315E−04 |
| P | 1.712E−07 | 9.069E−07 | 0.000E+00 | −2.722E−06 | −1.945E−04 | 1.875E−06 | −4.460E−05 | 3.497E−04 |
| Surface No. | S12 | S13 | S15 | S16 | S17 | S18 | S19 | S20 |
| K | 2.455E+01 | −8.955E+01 | −1.326E+00 | 9.605E+01 | −4.512E+01 | −9.008E−01 | 6.767E−01 | 9.900E+01 |
| A | −1.121E−01 | −2.252E−01 | −1.950E−01 | −2.956E−01 | −4.991E−02 | −1.060E−01 | 1.203E−01 | 4.653E−01 |
| B | −7.792E−02 | −1.051E−02 | −9.291E−03 | 1.121E−01 | 4.523E−02 | 1.689E−02 | 4.532E−02 | 8.417E−02 |
| C | 7.075E−02 | 1.234E−02 | 2.617E−02 | −2.862E−02 | −3.203E−02 | −1.470E−03 | 1.154E−02 | 2.179E−04 |
| D | −1.145E−02 | −2.118E−04 | −1.210E−02 | 1.882E−02 | 2.766E−03 | 1.377E−04 | 1.015E−03 | −1.979E−02 |
| E | −3.315E−03 | −1.964E−04 | −1.887E−02 | −1.836E−02 | −6.924E−03 | −7.107E−04 | −9.611E−04 | −1.494E−02 |
| F | −9.859E−03 | 7.008E−04 | 2.959E−04 | 2.302E−03 | 9.845E−03 | −4.288E−04 | −9.677E−04 | −4.801E−03 |
| G | 3.748E−03 | 1.030E−03 | 8.234E−03 | −3.724E−03 | −4.444E−03 | −3.442E−04 | −3.319E−04 | 2.873E−03 |
| H | 2.243E−03 | 4.490E−04 | 1.920E−03 | 5.357E−03 | −1.357E−03 | −1.957E−04 | −8.074E−05 | 5.191E−03 |
| J | 1.557E−03 | −2.801E−04 | −4.265E−03 | 2.470E−03 | −3.175E−03 | −1.277E−04 | −1.646E−05 | 3.997E−03 |
| L | −1.776E−03 | −5.833E−04 | −3.094E−03 | 4.052E−03 | 2.323E−03 | −9.474E−05 | −9.771E−05 | 1.719E−03 |
| M | 6.470E−05 | −5.022E−06 | 8.511E−04 | 1.490E−03 | 1.993E−03 | −3.843E−05 | −1.249E−04 | 1.610E−04 |
| N | 1.145E−03 | 3.111E−04 | 2.490E−03 | 1.070E−03 | 2.137E−03 | −4.832E−05 | −1.174E−04 | −4.020E−04 |
| O | 1.144E−03 | 2.743E−04 | 1.548E−03 | 3.032E−04 | 4.942E−04 | −1.379E−05 | −4.904E−05 | −2.959E−04 |
| P | 5.469E−04 | 1.051E−04 | 3.564E−04 | 9.308E−05 | 2.161E−05 | −4.628E−06 | −1.373E−05 | −9.715E−05 |

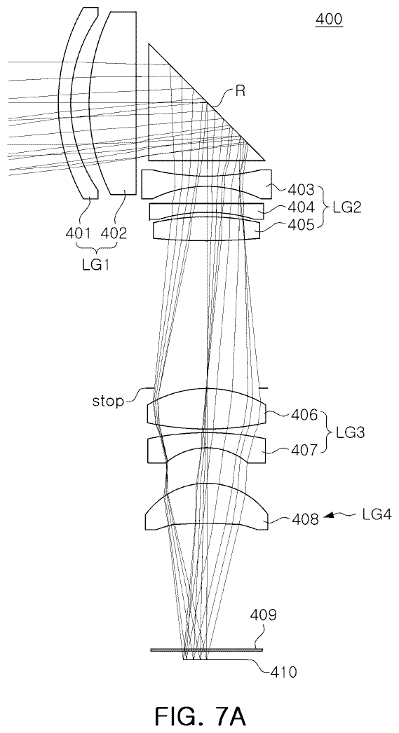

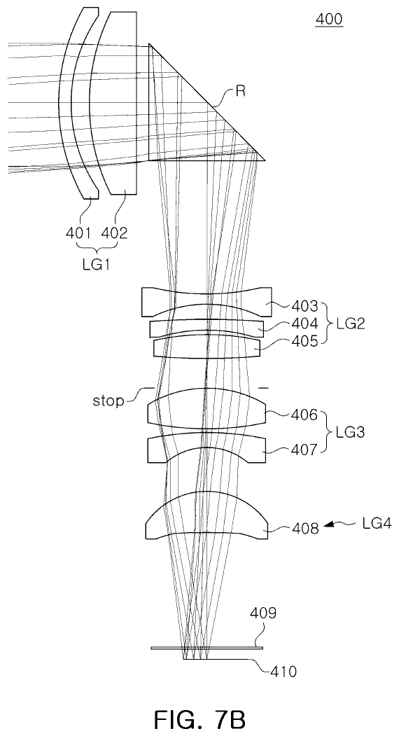

FIG. 7A is a diagram illustrating a wide-angle mode of an optical imaging system according to a fourth embodiment in the present disclosure, and FIG. 7B is a diagram illustrating a telephoto mode of the optical imaging system according to the fourth embodiment in the present disclosure.

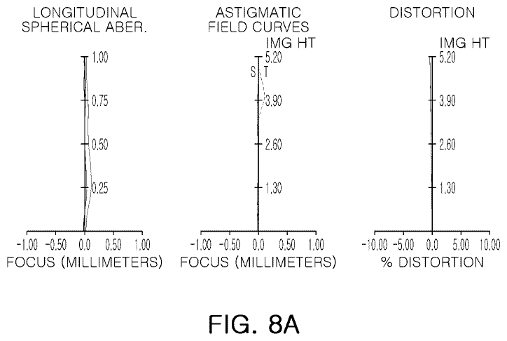

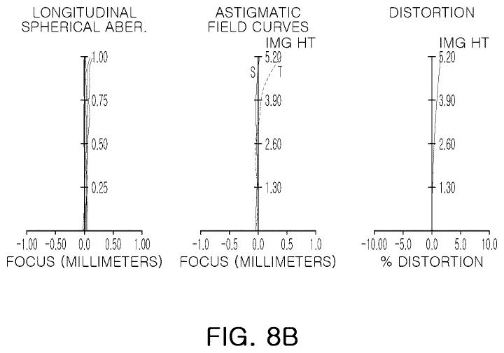

In addition, FIG. 8A is a diagram illustrating aberration characteristics of the wide-angle mode of the optical imaging system illustrated in FIG. 7A, and FIG. 8B is a diagram illustrating aberration characteristics of the telephoto mode of the optical imaging system illustrated in FIG. 7B.

The optical imaging system according to the fourth embodiment in the present disclosure includes a first lens group LG1, a second lens group LG2, a third lens group LG3, and a fourth lens group LG4.

In order from the object side of the optical imaging system, the first lens group LG1 includes a first lens 401 and a second lens 402, the second lens group LG2 includes a third lens 403, a fourth lens 404, and a fifth lens 405, the third lens group LG3 includes a sixth lens 406 and a seventh lens 407, and the fourth lens group LG4 includes an eighth lens 408.

In addition, the optical imaging system further includes a reflective member R disposed between the first lens group LG1 and the second lens group LG2, and a stop disposed between the second lens group LG2 and the third lens group LG3. The stop is aligned with an object-side surface of the third lens group LG3.

In addition, the optical imaging system may further include a filter 409 and an image sensor. The image sensor may include an imaging plane 410. The imaging plane 410 may refer to a surface on which a focus is formed by the optical imaging system.

The characteristics of each lens (a radius of curvature of each lens surface, a thickness of each lens or a distance between lenses, a refractive index of each lens, and an Abbe number of each lens) are illustrated in Table 10 below.

TABLE 10

| Surface | | Radius of | Thickness/ | Refractive | Abbe | |
|---|---|---|---|---|---|---|
| No. | Element | Curvature | Distance | Index | Number | Comment |
| S1 | First | 20.497 | 1.257 | 1.66 | 20.4 | First |
| S2 | Lens | 16.147 | 1.781 | | | Lens |
| S3 | Second | 20.909 | 5.007 | 1.535 | 56 | Group |
| S4 | Lens | −540.760 | 1.235 | | | |
| S5 | Reflective | Infinity | 6.000 | 1.717 | 29.5 | Reflective |
| S6 | Member | Infinity | 6.000 | 1.717 | 29.5 | Member |
| S7 | | Infinity | D1 | | | |
| S8 | Third | −16.036 | 0.972 | 1.544 | 56 | Second |
| S9 | Lens | 12.390 | 1.587 | | | Lens |
| S10 | Fourth | 49.829 | 1.130 | 1.544 | 56 | Group |
| S11 | Lens | 44.511 | 0.459 | | | |
| S12 | Fifth | 28.041 | 2.493 | 1.635 | 23.9 | |
| S13 | Lens | 664.279 | D2 | | | |
| S14 | Stop | Infinity | 0.000 | | | Stop |
| S15 | Sixth | 9.695 | 4.200 | 1.646 | 55.7 | Third |
| S16 | Lens | −68.193 | 0.266 | | | Lens |
| S17 | Seventh | 12.666 | 1.651 | 1.635 | 23.9 | Group |
| S18 | Lens | 5.137 | D3 | | | |
| S19 | Eighth | 9.102 | 4.141 | 1.535 | 56 | Fourth |
| S20 | Lens | 52.559 | D4 | | | Lens |
| | | | | | | Group |
| S21 | Filter | Infinity | 0.210 | 1.516 | 64.1 | Filter |
| S22 | | Infinity | 1.019 | | | |
| S23 | Imaging | Infinity | | | | Imaging |
| | Plane | | | | | Plane |

TABLE 11

| | Wide-Angle | Telephoto |
|---|---|---|
| Distance | Mode | Mode |
| D1 | 1.600 | 13.799 |
| D2 | 15.279 | 3.080 |
| D3 | 3.681 | 4.563 |
| D4 | 12.932 | 12.050 |

In Table 11 above, D1 is a distance along the optical axis between the reflective member R and the third lens 403, D2 is a distance along the optical axis between the fifth lens 405 and the sixth lens 406 (or the stop), D3 is a distance along the optical axis between the seventh lens 407 and the eighth lens 408, and D4 is a distance along the optical axis between the eighth lens 408 and the filter 409.

The focal length fG1 of the first lens group LG1 is 53.884 mm, the focal length fG2 of the second lens group LG2 is −18.446 mm, the focal length fG3 of the third lens group LG3 is 34.094 mm, and the focal length fG4 of the fourth lens group LG4 is 19.855 mm.

In the fourth embodiment in the present disclosure, the first lens group LG1 has a positive refractive power overall, the second lens group LG2 has a negative refractive power overall, the third lens group LG3 has a positive refractive power overall, and the fourth lens group LG4 has a positive refractive power overall.

The first lens 401 has a negative refractive power, the object-side surface of the first lens 401 is convex, and the image-side surface of the first lens 401 is concave.

The second lens 402 has a positive refractive power, and the object-side surface and the image-side surface of the second lens 402 are convex.

The reflective member R is disposed behind the second lens 402.

The third lens 403 has a negative refractive power, and the object-side surface and the image-side surface of the third lens 403 are concave.

The fourth lens 404 has a negative refractive power, the object-side surface of the fourth lens 404 is convex, and the image-side surface of the fourth lens 404 is concave.

The fifth lens 405 has a positive refractive power, the object-side surface of the fifth lens 405 is convex, and the image-side surface of the fifth lens 405 is concave.

The sixth lens 406 has a positive refractive power, and the object-side surface and the image-side surface of the sixth lens 406 are convex. The stop is disposed in front of the sixth lens 406, and is aligned with the object-side surface of the sixth lens 406. That is, a distance along the optical axis between the stop and the object-side surface of the sixth lens 406 is 0.

The seventh lens 407 has a negative refractive power, the object-side surface of the seventh lens 407 is convex, and the image-side surface of the seventh lens 407 is concave.

The eighth lens 408 has a positive refractive power, the object-side surface of the eighth lens 408 is convex, and the image-side surface of the eighth lens 408 is concave.

Each surface of the first lens 401 to the eighth lens 408 has the aspherical coefficients illustrated in Table 12 below. That is, each surface of the first lens 401 to the eighth lens 408 is aspherical.

TABLE 12

| Surface | | | | | | | | |
|---|---|---|---|---|---|---|---|---|
| No | S1 | S2 | S3 | S4 | S8 | S9 | S10 | S11 |
| K | 5.645E−01 | 2.836E−02 | −3.125E+00 | −3.435E+01 | −9.742E+00 | 1.961E+00 | 5.211E+01 | 6.236E+01 |
| A | −2.837E−01 | −5.593E−02 | 9.476E−01 | 2.368E−01 | 7.865E−01 | −3.006E−02 | −2.464E−02 | 3.258E−01 |
| B | 5.196E−03 | 2.733E−02 | 1.445E−02 | −1.543E−03 | −5.908E−02 | 6.891E−02 | −1.339E−01 | −3.493E−01 |
| C | 2.052E−02 | 3.843E−02 | 2.365E−02 | 4.239E−03 | −3.570E−02 | −3.771E−02 | −1.042E−02 | 8.552E−02 |
| D | −8.545E−03 | −8.917E−03 | −3.549E−03 | −2.342E−03 | 2.689E−02 | −1.684E−03 | −1.167E−02 | −1.264E−02 |
| E | 2.977E−03 | 3.159E−03 | 7.337E−04 | 2.497E−04 | −8.869E−03 | 5.019E−03 | 1.899E−02 | 1.121E−02 |
| F | −1.310E−03 | −1.583E−03 | −7.667E−04 | −5.411E−04 | 1.651E−02 | −1.755E−03 | −7.252E−03 | −2.283E−02 |
| G | 6.091E−04 | 5.849E−04 | 2.816E−05 | 1.236E−05 | −4.133E−03 | 9.480E−04 | −2.812E−04 | 2.055E−03 |
| H | −3.147E−04 | −3.742E−04 | −2.142E−04 | −7.342E−05 | −3.668E−03 | −1.828E−04 | −4.490E−03 | 1.935E−04 |
| J | 1.820E−04 | 2.217E−04 | 1.057E−04 | 6.305E−05 | 7.487E−04 | 1.309E−04 | −1.966E−03 | 6.995E−03 |
| L | −9.696E−05 | −7.275E−05 | 0.000E+00 | −2.795E−05 | 2.844E−03 | 0.000E+00 | −1.614E−03 | 2.859E−03 |
| M | 4.621E−05 | 4.913E−05 | 0.000E+00 | 8.153E−06 | 3.853E−03 | 0.000E+00 | −1.074E−03 | 1.373E−03 |
| N | −1.166E−05 | −5.390E−06 | 0.000E+00 | 4.579E−07 | 6.554E−04 | 0.000E+00 | −7.088E−04 | 7.454E−04 |
| O | 3.771E−07 | −5.749E−06 | 0.000E+00 | 1.109E−07 | −4.256E−04 | 0.000E+00 | −2.372E−04 | 4.923E−04 |
| P | 1.782E−07 | 1.010E−06 | 0.000E+00 | −1.054E−07 | −4.008E−04 | 0.000E+00 | −1.109E−04 | −2.222E−04 |
| Surface | | | | | | | | |
| No. | S12 | S13 | S15 | S16 | S17 | S18 | S19 | S20 |
| K | 2.123E+01 | −9.900E+01 | −1.602E+00 | 9.463E+01 | −3.536E+01 | −9.667E−01 | 7.106E−01 | 9.900E+01 |
| A | −3.323E−01 | −4.664E−01 | −5.471E−01 | −5.720E−01 | 1.088E−02 | −2.501E−01 | 2.354E−01 | 1.083E+00 |
| B | −5.152E−02 | 4.146E−02 | −3.660E−02 | 7.250E−02 | 3.764E−02 | 5.196E−02 | 1.032E−01 | 1.663E−01 |
| C | 8.302E−02 | 5.453E−03 | 1.047E−01 | 1.427E−02 | −3.512E−02 | −8.795E−03 | 3.465E−02 | −7.279E−03 |
| D | −9.651E−03 | −2.581E−03 | −1.660E−02 | 3.613E−02 | −5.648E−03 | 5.063E−04 | 3.844E−03 | −4.656E−02 |
| E | −4.864E−03 | −7.631E−04 | −5.939E−02 | −3.366E−02 | −9.094E−03 | −1.545E−03 | −5.055E−04 | −3.047E−02 |
| F | −1.248E−02 | 2.011E−03 | −4.320E−03 | −7.429E−03 | 1.950E−02 | 4.664E−04 | −5.749E−06 | −7.022E−03 |
| G | 1.076E−03 | 1.478E−03 | 2.636E−02 | −9.206E−03 | −6.221E−03 | −6.098E−04 | 1.860E−03 | 7.565E−03 |
| H | 1.568E−03 | 1.231E−03 | 9.796E−03 | 1.204E−02 | −5.365E−03 | 1.817E−04 | 1.489E−03 | 9.765E−03 |
| J | 3.614E−03 | 9.237E−04 | −1.227E−02 | 8.774E−03 | −8.344E−03 | 1.347E−04 | 4.339E−04 | 6.217E−03 |
| L | 1.127E−04 | 2.575E−04 | −1.133E−02 | 1.099E−02 | 6.083E−03 | 1.205E−04 | −7.296E−05 | 2.425E−03 |
| M | 1.151E−04 | −2.381E−04 | 1.553E−04 | 5.673E−03 | 5.938E−03 | 1.091E−04 | −8.830E−05 | 5.751E−04 |
| N | 4.633E−04 | −3.118E−04 | 5.434E−03 | 3.571E−03 | 3.753E−03 | −3.410E−06 | −8.037E−05 | −1.164E−04 |
| O | 1.940E−04 | −1.739E−04 | 3.536E−03 | 1.125E−03 | 4.857E−05 | −1.537E−05 | −6.369E−05 | −1.814E−04 |
| P | −3.540E−04 | −9.416E−05 | 8.125E−04 | 1.893E−04 | −4.827E−04 | −1.141E−05 | −3.283E−05 | −1.117E−04 |

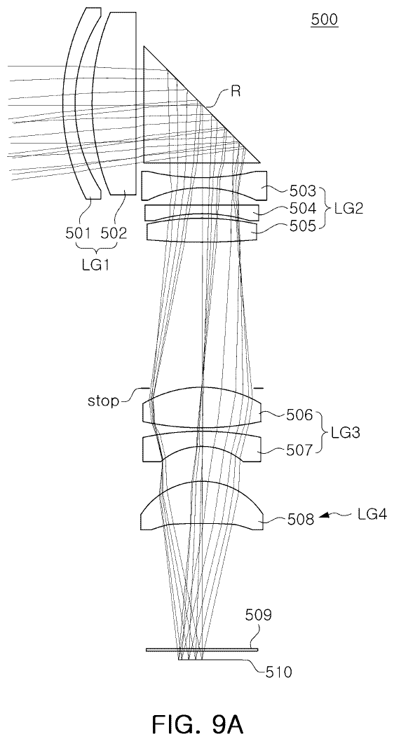

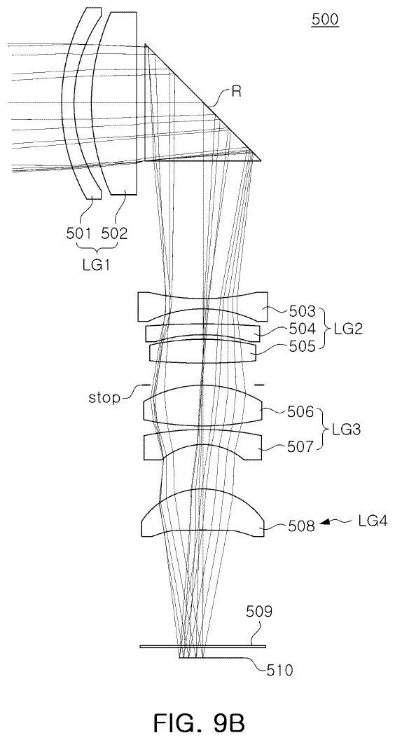

FIG. 9A is a diagram illustrating a wide-angle mode of an optical imaging system according to a fifth embodiment in the present disclosure, and FIG. 9B is a diagram illustrating a telephoto mode of the optical imaging system according to the fifth embodiment in the present disclosure.

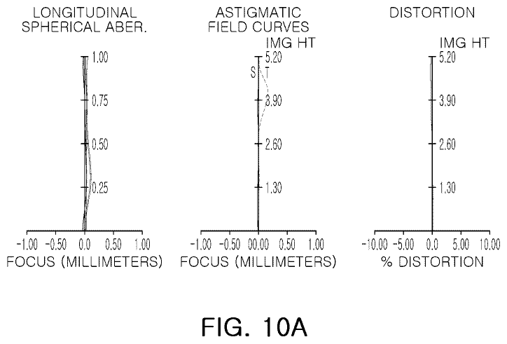

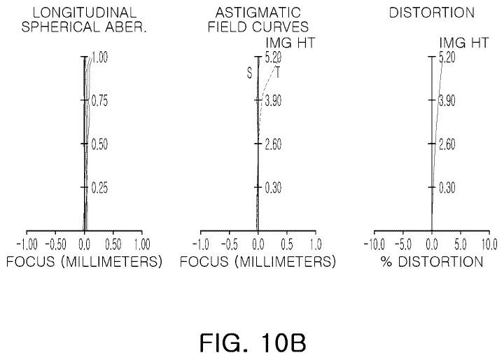

In addition, FIG. 10A is a diagram illustrating aberration characteristics of the wide-angle mode of the optical imaging system illustrated in FIG. 9A, and FIG. 10B is a diagram illustrating aberration characteristics of the telephoto mode of the optical imaging system illustrated in FIG. 9B.

The optical imaging system according to the fifth embodiment in the present disclosure includes a first lens group LG1, a second lens group LG2, a third lens group LG3, and a fourth lens group LG4.

In order from the object side of the optical imaging system, the first lens group LG1 includes a first lens 501 and a second lens 502, the second lens group LG2 includes a third lens 503, a fourth lens 504, and a fifth lens 505, the third lens group LG3 includes a sixth lens 506 and a seventh lens 507, and the fourth lens group LG4 includes an eighth lens 508.

In addition, the optical imaging system further includes a reflective member R disposed between the first lens group LG1 and the second lens group LG2, and a stop disposed between the second lens group LG2 and the third lens group LG3. The stop is aligned with an object-side surface of the third lens group LG3.

In addition, the optical imaging system may further include a filter 509 and an image sensor. The image sensor may include an imaging plane 510. The imaging plane 510 may refer to a surface on which a focus is formed by the optical imaging system.

The characteristics of each lens (a radius of curvature of each lens surface, a thickness of each lens or a distance between lenses, a refractive index of each lens, and an Abbe number of each lens) are illustrated in Table 13 below.

TABLE 13

| Surface | | Radius of | Thickness/ | Refractive | Abbe | |
|---|---|---|---|---|---|---|
| No. | Element | Curvature | Distance | Index | Number | Comment |
| S1 | First | 20.544 | 1.200 | 1.66 | 20.4 | First |
| S2 | Lens | 16.168 | 1.800 | | | Lens |
| S3 | Second | 20.979 | 4.593 | 1.535 | 56 | Group |
| S4 | Lens | −460.673 | 0.800 | | | |
| S5 | Reflective | Infinity | 6.000 | 1.717 | 29.5 | Reflective |
| S6 | Member | Infinity | 6.000 | 1.717 | 29.5 | Member |
| S7 | | Infinity | D1 | | | |
| S8 | Third | −16.026 | 1.024 | 1.544 | 56 | Second |
| S9 | Lens | 12.308 | 1.633 | | | Lens |
| S10 | Fourth | 48.533 | 1.087 | 1.544 | 56 | Group |
| S11 | Lens | 44.737 | 0.498 | | | |
| S12 | Fifth | 28.119 | 2.427 | 1.635 | 23.9 | |
| S13 | Lens | −3013.147 | D2 | | | |
| S14 | Stop | Infinity | 0.000 | | | Stop |
| S15 | Sixth | 9.696 | 4.200 | 1.642 | 56.5 | |
| S16 | Lens | −68.124 | 0.253 | | | |
| S17 | Seventh | 12.661 | 1.662 | 1.635 | 23.9 | Third |
| S18 | Lens | 5.137 | D3 | | | Lens |
| | | | | | | Group |
| S19 | Eighth | 9.168 | 4.145 | 1.535 | 56 | Fourth |
| S20 | Lens | 53.857 | D4 | | | Lens |
| | | | | | | Group |
| S21 | Filter | Infinity | 0.210 | 1.516 | 64.1 | Filter |
| S22 | | Infinity | 1.019 | | | |
| S23 | Imaging | Infinity | | | | Imaging |
| | Plane | | | | | Plane |

TABLE 14

| | Wide-Angle | Telephoto |
|---|---|---|
| Distance | Mode | Mode |
| D1 | 1.600 | 14.199 |
| D2 | 14.873 | 2.274 |
| D3 | 3.634 | 4.687 |
| D4 | 13.013 | 11.959 |

In Table 14 above, D1 is a distance along the optical axis between the reflective member R and the third lens 503, D2 is a distance along the optical axis between the fifth lens 505 and the sixth lens 506 (or the stop), D3 is a distance along the optical axis between the seventh lens 507 and the eighth lens 508, and D4 is a distance along the optical axis between the eighth lens 508 and the filter 509.

The focal length fG1 of the first lens group LG1 is 53.748 mm, the focal length fG2 of the second lens group LG2 is −19.029 mm, the focal length fG3 of the third lens group LG3 is 34.694 mm, and the focal length fG4 of the fourth lens group LG4 is 19.944 mm.

In the fifth embodiment in the present disclosure, the first lens group LG1 has a positive refractive power overall, the second lens group LG2 has a negative refractive power overall, the third lens group LG3 has a positive refractive power overall, and the fourth lens group LG4 has a positive refractive power overall.

The first lens 501 has a negative refractive power, the object-side surface of the first lens 501 is convex, and the image-side surface of the first lens 501 is concave.

The second lens 502 has a positive refractive power, and the object-side surface and the image-side surface of the second lens 502 are convex.

The reflective member R is disposed behind the second lens 502.

The third lens 503 has a negative refractive power, and the object-side surface and the image-side surface of the third lens 503 are concave.

The fourth lens 504 has a negative refractive power, the object-side surface of the fourth lens 504 is convex, and the image-side surface of the fourth lens 504 is concave.

The fifth lens 505 has a positive refractive power, and the object-side surface and the image-side surface of the fifth lens 505 are convex.

The sixth lens 506 has a positive refractive power, and the object-side surface and the image-side surface of the sixth lens 506 are convex. The stop is disposed in front of the sixth lens 506, and is aligned with the object-side surface of the sixth lens 506. That is, a distance along the optical axis between the stop and the object-side surface of the sixth lens 506 is 0.

The seventh lens 507 has a negative refractive power, the object-side surface of the seventh lens 507 is convex, and the image-side surface of the seventh lens 507 is concave.

The eighth lens 508 has a positive refractive power, the object-side surface of the eighth lens 508 is convex, and the image-side surface of the eighth lens 508 is concave.

Each surface of the first lens 501 to the eighth lens 508 has the aspherical coefficients illustrated in Table 15 below. That is, each surface of the first lens 501 to the eighth lens 508 is aspherical.

TABLE 15

| Surface | | | | | | | | |
|---|---|---|---|---|---|---|---|---|
| No. | S1 | S2 | S3 | S4 | S8 | S9 | S10 | S11 |
| K | 5.657E−01 | 2.865E−02 | −3.119E+00 | 6.905E+01 | −9.733E+00 | 1.965E+00 | 5.198E+01 | 6.227E+01 |
| A | −2.841E−01 | −5.520E−02 | 9.481E−01 | 2.350E−01 | 7.879E−01 | −5.446E−02 | −2.369E−02 | 3.249E−01 |
| B | 6.018E−03 | 2.684E−02 | 1.415E−02 | −1.195E−03 | −5.755E−02 | −8.226E−03 | −1.351E−01 | −3.482E−01 |
| C | 2.085E−02 | 3.834E−02 | 2.347E−02 | 4.689E−03 | −3.676E−02 | −9.003E−02 | −1.195E−02 | 8.541E−02 |
| D | −8.498E−03 | −8.948E−03 | −3.627E−03 | −2.354E−03 | 2.610E−02 | 2.055E−02 | −1.353E−02 | −1.265E−02 |
| E | 2.967E−03 | 3.193E−03 | 7.101E−04 | 2.627E−04 | −7.637E−03 | −6.949E−03 | 1.739E−02 | 1.111E−02 |
| F | −1.313E−03 | −1.579E−03 | −7.836E−04 | −5.310E−04 | 1.606E−02 | −1.221E−02 | −7.934E−03 | −2.316E−02 |
| G | 6.052E−04 | 5.978E−04 | 1.894E−05 | 1.020E−05 | −4.256E−03 | 1.041E−03 | −4.917E−04 | 2.383E−03 |
| H | −3.153E−04 | −3.786E−04 | −2.125E−04 | −7.533E−05 | −3.816E−03 | −1.146E−03 | −4.642E−03 | 3.454E−04 |
| J | 1.816E−04 | 2.223E−04 | 1.046E−04 | 6.268E−05 | 1.244E−03 | −1.092E−04 | −1.366E−03 | 7.054E−03 |
| L | −9.711E−05 | −7.263E−05 | 0.000E+00 | −2.826E−05 | 2.672E−03 | −8.977E−04 | −6.756E−04 | 2.691E−03 |
| M | 4.618E−05 | 4.899E−05 | 0.000E+00 | 8.078E−06 | 3.572E−03 | 1.498E−03 | −4.836E−04 | 1.177E−03 |
| N | −1.167E−05 | −5.489E−06 | 0.000E+00 | 4.444E−07 | 7.164E−04 | 1.938E−03 | −2.969E−04 | 7.349E−04 |
| O | 3.789E−07 | −5.806E−06 | 0.000E+00 | 9.350E−08 | 1.693E−05 | 1.154E−03 | −1.060E−04 | 5.276E−04 |
| P | 1.802E−07 | 9.804E−07 | 0.000E+00 | −1.165E−07 | −6.197E−04 | 3.650E−04 | −3.882E−05 | −7.138E−05 |
| Surface | | | | | | | | |
| No. | S12 | S13 | S15 | S16 | S17 | S18 | S19 | S20 |
| K | 2.126E+01 | −9.900E+01 | −1.597E+00 | 9.502E+01 | −3.544E+01 | −9.659E−01 | 7.117E−01 | 9.900E+01 |
| A | −3.332E−01 | −4.654E−01 | −5.447E−01 | −5.733E−01 | 9.254E−03 | −2.497E−01 | 2.372E−01 | 1.081E+00 |
| B | −5.001E−02 | 4.095E−02 | −3.794E−02 | 7.383E−02 | 3.853E−02 | 5.182E−02 | 1.020E−01 | 1.665E−01 |
| C | 8.237E−02 | 5.305E−03 | 1.053E−01 | 1.401E−02 | −3.537E−02 | −8.602E−03 | 3.530E−02 | −6.976E−03 |
| D | −9.544E−03 | −2.851E−03 | −1.653E−02 | 3.609E−02 | −5.909E−03 | 3.465E−04 | 3.886E−03 | −4.676E−02 |
| E | −4.645E−03 | −4.161E−04 | −5.954E−02 | −3.361E−02 | −8.714E−03 | −1.567E−03 | −6.657E−04 | −3.060E−02 |
| F | −1.267E−02 | 2.101E−03 | −4.302E−03 | −7.455E−03 | 1.927E−02 | 4.141E−04 | 9.162E−05 | −6.855E−03 |
| G | 9.893E−04 | 1.390E−03 | 2.642E−02 | −9.163E−03 | −6.141E−03 | −5.324E−04 | 1.792E−03 | 7.494E−03 |
| H | 1.622E−03 | 1.135E−03 | 9.774E−03 | 1.200E−02 | −5.426E−03 | 1.830E−04 | 1.529E−03 | 9.740E−03 |
| J | 3.696E−03 | 8.948E−04 | −1.230E−02 | 8.800E−03 | −8.247E−03 | 1.431E−04 | 4.491E−04 | 6.226E−03 |
| L | 2.141E−04 | 2.767E−04 | −1.130E−02 | 1.097E−02 | 5.990E−03 | 1.149E−04 | −7.592E−05 | 2.414E−03 |
| M | 6.002E−05 | −1.842E−04 | 1.603E−04 | 5.656E−03 | 5.960E−03 | 1.090E−04 | −1.170E−04 | 5.653E−04 |
| N | 2.638E−04 | −3.069E−04 | 5.425E−03 | 3.604E−03 | 3.781E−03 | −5.236E−06 | −8.042E−05 | −1.024E−04 |
| O | 2.182E−04 | −1.347E−04 | 3.522E−03 | 1.116E−03 | 2.662E−05 | −1.558E−05 | −4.170E−05 | −1.618E−04 |
| P | −2.294E−04 | −6.582E−05 | 8.111E−04 | 1.988E−04 | −4.720E−04 | −1.075E−05 | −1.338E−05 | −9.280E−05 |

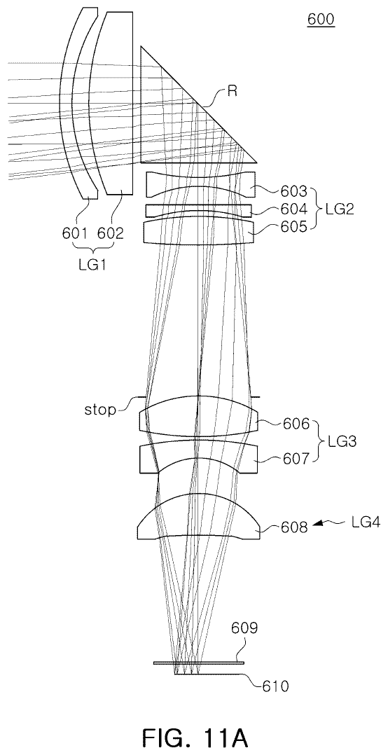

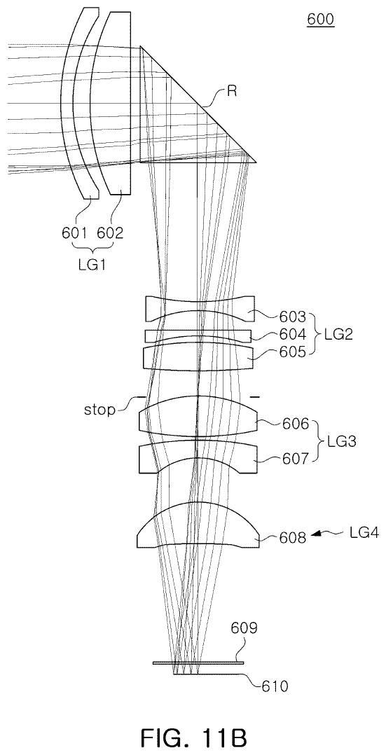

FIG. 11A is a diagram illustrating a wide-angle mode of an optical imaging system according to a sixth embodiment in the present disclosure, and FIG. 11B is a diagram illustrating a telephoto mode of the optical imaging system according to the sixth embodiment in the present disclosure.

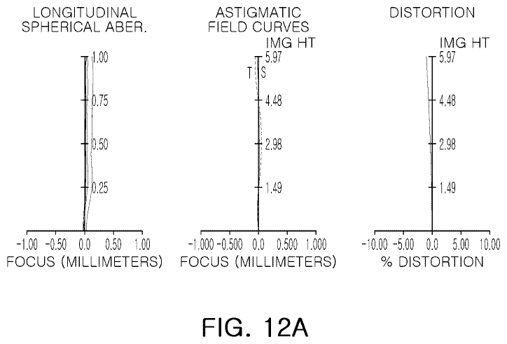

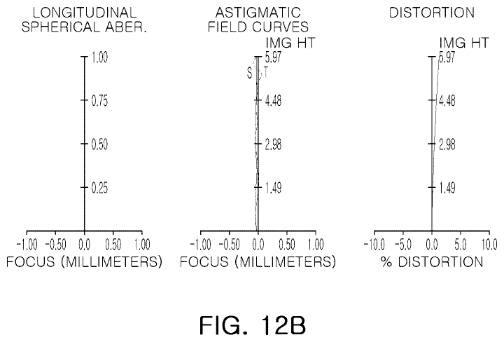

In addition, FIG. 12A is a diagram illustrating aberration characteristics of the wide-angle mode of the optical imaging system illustrated in FIG. 11A, and FIG. 12B is a diagram illustrating aberration characteristics of the telephoto mode of the optical imaging system illustrated in FIG. 11B.

The optical imaging system according to the sixth embodiment in the present disclosure includes a first lens group LG1, a second lens group LG2, a third lens group LG3, and a fourth lens group LG4.

In order from the object side of the optical imaging system, the first lens group LG1 includes a first lens 601 and a second lens 602, the second lens group LG2 includes a third lens 603, a fourth lens 604, and a fifth lens 605, the third lens group LG3 includes a sixth lens 606 and a seventh lens 607, and the fourth lens group LG4 includes an eighth lens 608.

In addition, the optical imaging system further includes a reflective member R disposed between the first lens group LG1 and the second lens group LG2, and a stop disposed between the second lens group LG2 and the third lens group LG3. The stop is aligned with an object-side surface of the third lens group LG3.

In addition, the optical imaging system may further include a filter 609 and an image sensor. The image sensor may include an imaging plane 610. The imaging plane 610 may refer to a surface on which a focus is formed by the optical imaging system.

The characteristics of each lens (a radius of curvature of each lens surface, a thickness of each lens or a distance between lenses, a refractive index of each lens, and an Abbe number of each lens) are illustrated in Table 16 below.

TABLE 16

| Surface | | Radius of | Thickness/ | Refractive | Abbe | |
|---|---|---|---|---|---|---|
| No. | Element | Curvature | Distance | Index | Number | Comment |
| S1 | First | 20.466 | 1.200 | 1.66 | 20.4 | First |
| S2 | Lens | 16.120 | 1.777 | | | Lens |
| S3 | Second | 20.988 | 4.272 | 1.535 | 56 | Group |
| S4 | Lens | −865.240 | 0.901 | | | |
| S5 | Reflective | Infinity | 6.000 | 1.717 | 29.5 | Reflective |
| S6 | Member | Infinity | 6.000 | 1.717 | 29.5 | Member |
| S7 | | Infinity | D1 | | | |
| S8 | Third | −15.940 | 0.911 | 1.544 | 56 | Second |
| S9 | Lens | 12.791 | 1.692 | | | Lens |
| S10 | Fourth | 58.676 | 0.874 | 1.544 | 56 | Group |
| S11 | Lens | 48.548 | 0.562 | | | |
| S12 | Fifth | 29.584 | 2.928 | 1.635 | 23.9 | |
| S13 | Lens | −371.542 | D2 | | | |
| S14 | Stop | Infinity | 0.000 | | | Stop |
| S15 | Sixth | 9.697 | 4.189 | 1.623 | 59.4 | Third |
| S16 | Lens | −68.235 | 0.246 | | | Lens |
| S17 | Seventh | 12.656 | 1.973 | 1.635 | 23.9 | Group |
| S18 | Lens | 5.085 | D3 | | | |
| S19 | Eighth | 9.130 | 4.197 | 1.535 | 56 | Fourth |
| S20 | Lens | 54.776 | D4 | | | Lens |
| | | | | | | Group |
| S21 | Filter | Infinity | 0.210 | 1.516 | 64.1 | Filter |
| S22 | | Infinity | 1.069 | | | |
| S23 | Imaging | Infinity | | | | Imaging |
| | Plane | | | | | Plane |

TABLE 17

| | Wide-Angle | Telephoto |
|---|---|---|
| Distance | Mode | Mode |
| D1 | 1.600 | 14.496 |
| D2 | 15.471 | 2.575 |
| D3 | 3.731 | 4.556 |
| D4 | 13.097 | 12.272 |

In Table 17 above, D1 is a distance along the optical axis between the reflective member R and the third lens 603, D2 is a distance along the optical axis between the fifth lens 605 and the sixth lens 606 (or the stop), D3 is a distance along the optical axis between the seventh lens 607 and the eighth lens 608, and D4 is a distance along the optical axis between the eighth lens 608 and the filter 609.

The focal length fG1 of the first lens group LG1 is 55.277 mm, the focal length fG2 of the second lens group LG2 is −19.455 mm, the focal length fG3 of the third lens group LG3 is 35.871 mm, and the focal length fG4 of the fourth lens group LG4 is 19.944 mm.

In the sixth embodiment in the present disclosure, the first lens group LG1 has a positive refractive power overall, the second lens group LG2 has a negative refractive power overall, the third lens group LG3 has a positive refractive power overall, and the fourth lens group LG4 has a positive refractive power overall.

The first lens 601 has a negative refractive power, the object-side surface of the first lens 601 is convex, and the image-side surface of the first lens 601 is concave.

The second lens 602 has a positive refractive power, and the object-side surface and the image-side surface of the second lens 602 are convex.

The reflective member R is disposed behind the second lens 602.

The third lens 603 has a negative refractive power, and the object-side surface and the image-side surface of the third lens 603 are concave.

The fourth lens 604 has a negative refractive power, the object-side surface of the fourth lens 604 is convex, and the image-side surface of the fourth lens 604 is concave.

The fifth lens 605 has a positive refractive power, and the object-side surface and the image-side surface of the fifth lens 605 are convex.

The sixth lens 606 has a positive refractive power, and the object-side surface and the image-side surface of the sixth lens 606 are convex. The stop is disposed in front of the sixth lens 606, and is aligned with the object-side surface of the sixth lens 606. That is, a distance along the optical axis between the stop and the object-side surface of the sixth lens 606 is 0.

The seventh lens 607 has a negative refractive power, the object-side surface of the seventh lens 607 is convex, and the image-side surface of the seventh lens 607 is concave.

The eighth lens 608 has a positive refractive power, the object-side surface of the eighth lens 608 is convex, and the image-side surface of the eighth lens 608 is concave.

Each surface of the first lens 601 to the eighth lens 608 has the aspherical coefficients illustrated in Table 18 below. That is, each surface of the first lens 601 to the eighth lens 608 is aspherical.

TABLE 18

| Surface | | | | | | | | |
|---|---|---|---|---|---|---|---|---|
| No. | S1 | S2 | S3 | S4 | S8 | S9 | S10 | S11 |
| K | 5.677E−01 | 2.413E−02 | −2.884E+00 | −9.900E+01 | −1.023E+01 | 1.717E+00 | 3.794E+01 | 6.039E+01 |
| A | −2.848E−01 | −6.353E−02 | 9.663E−01 | 2.464E−01 | 8.448E−01 | −7.756E−02 | −2.275E−02 | 3.238E−01 |
| B | 6.876E−03 | 2.569E−02 | 5.247E−03 | −6.608E−03 | −6.366E−02 | −1.511E−02 | −1.458E−01 | −3.468E−01 |
| C | 2.223E−02 | 4.044E−02 | 2.148E−02 | 3.329E−03 | −4.301E−02 | −8.660E−02 | −2.126E−02 | 8.007E−02 |
| D | −8.563E−03 | −9.084E−03 | −3.330E−03 | −1.475E−03 | 2.710E−02 | 1.862E−02 | −2.394E−02 | −1.108E−02 |
| E | 2.896E−03 | 3.073E−03 | 4.798E−04 | 4.217E−04 | −1.076E−03 | −7.128E−04 | 1.148E−02 | 1.157E−02 |
| F | −1.314E−03 | −1.501E−03 | −7.553E−04 | −4.052E−04 | 1.090E−02 | −1.256E−02 | −9.825E−03 | −2.425E−02 |
| G | 6.030E−04 | 6.299E−04 | 7.687E−05 | 8.881E−05 | −4.205E−03 | −3.542E−03 | 1.313E−03 | 5.564E−03 |
| H | −3.243E−04 | −2.833E−04 | −1.039E−04 | −8.876E−05 | −3.605E−03 | −1.945E−03 | −4.273E−03 | −5.713E−04 |
| J | 1.816E−04 | 2.643E−04 | 1.571E−04 | 7.502E−05 | 2.656E−03 | 2.745E−03 | −1.428E−03 | 6.560E−03 |
| L | −9.565E−05 | −5.058E−05 | 0.000E+00 | −3.247E−05 | 3.196E−03 | 6.889E−04 | −9.569E−04 | 2.029E−03 |
| M | 4.671E−05 | 5.470E−05 | 0.000E+00 | 4.659E−06 | 2.196E−03 | 5.764E−04 | 6.662E−04 | 8.188E−04 |
| N | −1.143E−05 | −1.455E−06 | 0.000E+00 | −8.063E−07 | −1.247E−03 | 1.940E−04 | 1.625E−04 | 5.930E−04 |
| O | 4.970E−07 | −6.302E−06 | 0.000E+00 | −8.063E−08 | −8.847E−04 | 1.069E−04 | −1.229E−04 | −7.496E−05 |
| P | 1.949E−07 | 1.740E−06 | 0.000E+00 | 2.495E−07 | −6.197E−04 | 3.177E−05 | −2.834E−05 | 1.385E−04 |
| Surface | | | | | | | | |
| No. | S12 | S13 | S15 | S16 | S17 | S18 | S19 | S20 |
| K | 2.153E+01 | −7.669E+01 | −1.558E+00 | 9.897E+01 | −3.521E+01 | −9.402E−01 | 6.386E−01 | 9.900E+01 |
| A | −3.464E−01 | −4.669E−01 | −5.265E−01 | −5.898E−01 | 1.995E−02 | −2.358E−01 | 2.137E−01 | 1.062E+00 |
| B | −3.574E−02 | 2.248E−02 | −4.681E−02 | 8.945E−02 | 3.897E−02 | 5.482E−02 | 1.008E−01 | 1.634E−01 |
| C | 8.235E−02 | 7.675E−03 | 1.114E−01 | 1.304E−02 | −4.144E−02 | −1.124E−02 | 3.881E−02 | −4.064E−03 |
| D | −9.377E−03 | −2.124E−03 | −1.886E−02 | 3.366E−02 | −4.565E−03 | 4.991E−04 | 5.199E−03 | −4.541E−02 |
| E | −6.915E−03 | 8.150E−04 | −5.878E−02 | −3.215E−02 | −6.196E−03 | −2.029E−03 | −2.014E−03 | −3.070E−02 |
| F | −1.385E−02 | 2.435E−03 | −3.831E−03 | −8.743E−03 | 1.661E−02 | 3.242E−04 | −6.907E−04 | 7.541E−03 |
| G | 2.976E−03 | 2.044E−03 | 2.655E−02 | −7.511E−03 | −5.213E−03 | −2.175E−04 | 1.744E−03 | 6.985E−03 |
| H | 1.928E−03 | 6.437E−04 | 8.997E−03 | 1.149E−02 | −5.932E−03 | 4.552E−04 | 2.327E−03 | 1.006E−02 |
| J | 3.235E−03 | −2.245E−04 | −1.244E−02 | 9.295E−03 | −7.013E−03 | 1.735E−04 | 9.988E−04 | 6.937E−03 |
| L | 3.277E−04 | −4.500E−04 | −1.079E−02 | 1.050E−02 | 4.959E−03 | 5.386E−05 | −4.434E−04 | 2.725E−03 |
| M | 6.746E−05 | −2.808E−04 | 5.640E−04 | 5.003E−03 | 5.815E−03 | −6.350E−05 | −1.147E−03 | 1.286E−04 |
| N | 1.887E−04 | −7.569E−05 | 5.455E−03 | 3.030E−03 | 4.196E−03 | −1.320E−04 | −9.896E−04 | −7.325E−04 |
| O | −5.181E−05 | −2.207E−05 | 3.337E−03 | 6.830E−04 | 5.469E−04 | −6.709E−05 | −4.649E−04 | −5.044E−04 |
| P | 8.365E−05 | 1.237E−05 | 7.344E−04 | 9.558E−05 | −2.173E−04 | −1.805E−05 | −1.121E−04 | −1.650E−04 |

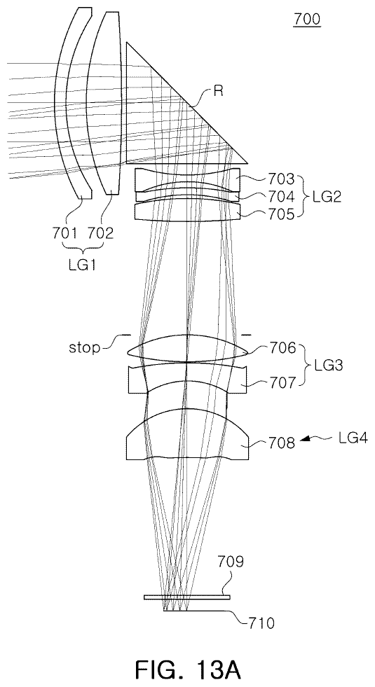

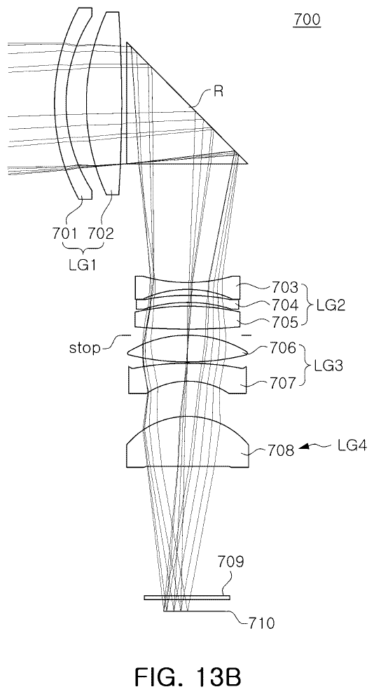

FIG. 13A is a diagram illustrating a wide-angle mode of an optical imaging system according to a seventh embodiment in the present disclosure, and FIG. 13B is a diagram illustrating a telephoto mode of the optical imaging system according to the seventh embodiment in the present disclosure.

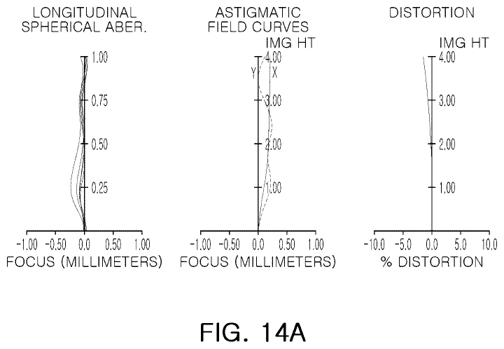

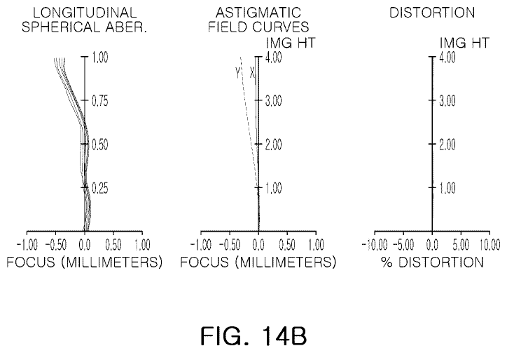

In addition, FIG. 14A is a diagram illustrating aberration characteristics of the wide-angle mode of the optical imaging system illustrated in FIG. 13A, and FIG. 14B is a diagram illustrating aberration characteristics of the telephoto mode of the optical imaging system illustrated in FIG. 13B.

The optical imaging system according to the seventh embodiment in the present disclosure includes a first lens group LG1, a second lens group LG2, a third lens group LG3, and a fourth lens group LG4.

In order from the object side of the optical imaging system, the first lens group LG1 includes a first lens 701 and a second lens 702, the second lens group LG2 includes a third lens 703, a fourth lens 704, and a fifth lens 705, the third lens group LG3 includes a sixth lens 706 and a seventh lens 707, and the fourth lens group LG4 includes an eighth lens 708.

In addition, the optical imaging system further includes a reflective member R disposed between the first lens group LG1 and the second lens group LG2, and a stop disposed between the second lens group LG2 and the third lens group LG3. The stop is aligned with an object-side surface of the third lens group LG3.

In addition, the optical imaging system may further include a filter 709 and an image sensor. The image sensor may include an imaging plane 710. The imaging plane 710 may refer to a surface on which a focus is formed by the optical imaging system.

The characteristics of each lens (a radius of curvature of each lens surface, a thickness of each lens or a distance between lenses, a refractive index of each lens, and an Abbe number of each lens) are illustrated in Table 19 below.

TABLE 19

| Surface | | Radius of | Thickness/ | Refractive | Abbe | |
|---|---|---|---|---|---|---|
| No. | Element | Curvature | Distance | Index | Number | Comment |
| S1 | First | 20.501 | 1.176 | 1.66 | 20.4 | First |
| S2 | Lens | 16.662 | 2.165 | | | Lens |
| S3 | Second | 22.712 | 3.669 | 1.535 | 56 | Group |
| S4 | Lens | −130.921 | 0.522 | | | |
| S5 | Reflective | Infinity | 6.249 | 1.717 | 29.5 | Reflective |
| S6 | Member | Infinity | 6.249 | 1.717 | 29.5 | Member |
| S7 | | Infinity | 1.206 | | | |
| S8 | Third | −16.122 | 0.700 | 1.544 | 56 | Second |
| S9 | Lens | 10.171 | 0.645 | | | Lens |
| S10 | Fourth | 26.619 | 0.700 | 1.544 | 56 | Group |
| S11 | Lens | 41.166 | 0.387 | | | |
| S12 | Fifth | 27.523 | 2.309 | 1.635 | 23.9 | |
| S13 | Lens | 116.039 | 11.889 | | | |
| S14 | Stop | Infinity | 0.000 | | | Stop |
| S15 | Sixth | 9.768 | 2.775 | 1.558 | 55.1 | Third |
| S16 | Lens | −66.264 | 0.089 | | | Lens |
| S17 | Seventh | 13.718 | 1.903 | 1.635 | 23.9 | Group |
| S18 | Lens | 5.803 | 2.872 | | | |
| S19 | Eighth | 10.112 | 5.152 | 1.535 | 56 | Fourth |
| S20 | Lens | −61.912 | 14.278 | | | Lens |
| | | | | | | Group |
| S21 | Filter | Infinity | 0.437 | 1.516 | 64.1 | Filter |
| S22 | | Infinity | 1.119 | | | |
| S23 | Imaging | Infinity | | | | Imaging |
| | Plane | | | | | Plane |

TABLE 20

| | Wide-Angle | Telephoto |
|---|---|---|
| Distance | Mode | Mode |
| D1 | 1.206 | 12.345 |
| D2 | 11.889 | 0.750 |
| D3 | 2.872 | 3.723 |
| D4 | 14.278 | 13.428 |

In Table 20 above, D1 is a distance along the optical axis between the reflective member R and the third lens 703, D2 is a distance along the optical axis between the fifth lens 705 and the sixth lens 706 (or the stop), D3 is a distance along the optical axis between the seventh lens 707 and the eighth lens 708, and D4 is a distance along the optical axis between the eighth lens 708 and the filter 709.

The focal length fG1 of the first lens group LG1 is 48.256 mm, the focal length fG2 of the second lens group LG2 is −16.347 mm, the focal length fG3 of the third lens group LG3 is 45.775 mm, and the focal length fG4 of the fourth lens group LG4 is 16.614 mm.

In the seventh embodiment in the present disclosure, the first lens group LG1 has a positive refractive power overall, the second lens group LG2 has a negative refractive power overall, the third lens group LG3 has a positive refractive power overall, and the fourth lens group LG4 has a positive refractive power overall.

The first lens 701 has a negative refractive power, the object-side surface of the first lens 701 is convex, and the image-side surface of the first lens 701 is concave.

The second lens 702 has a positive refractive power, and the object-side surface and the image-side surface of the second lens 702 are convex.

The reflective member R is disposed behind the second lens 702.

The third lens 703 has a negative refractive power, and the object-side surface and the image-side surface of the third lens 703 are concave.

The fourth lens 704 has a positive refractive power, the object-side surface of the fourth lens 704 is convex, and the image-side surface of the fourth lens 704 is concave.

The fifth lens 705 has a positive refractive power, the object-side surface of the fifth lens 705 is convex, and the image-side surface of the fifth lens 705 is concave.

The sixth lens 706 has a positive refractive power, and the object-side surface and the image-side surface of the sixth lens 706 are convex. The stop is disposed in front of the sixth lens 706, and is aligned with an object-side surface of the sixth lens 706. That is, a distance along the optical axis between the stop and the object-side surface of the sixth lens 706 is 0.

The seventh lens 707 has a negative refractive power, the object-side surface of the seventh lens 707 is convex, and the image-side surface of the seventh lens 707 is concave.

The eighth lens 708 has a positive refractive power, and the object-side surface and the image-side surface of the eighth lens 708 are convex.

Each surface of the first lens 701 to the eighth lens 708 has the aspherical coefficients illustrated in Table 21 below. That is, each surface of the first lens 701 to the eighth lens 708 is an aspherical surface.

TABLE 21

| Surface No. | S1 | S2 | S3 | S4 | S8 | S9 | S10 | S11 |
|---|---|---|---|---|---|---|---|---|
| K | 4.972E−01 | −1.827E−02 | −3.478E+00 | −5.070E+01 | −1.093E+01 | 2.510E−01 | 5.593E−01 | 6.972E+01 |
| A | 5.690E−05 | 1.399E−04 | 6.345E−05 | −6.257E−05 | 8.120E−04 | 3.726E−03 | 3.718E−03 | 3.987E−01 |
| B | −5.248E−06 | −1.008E−05 | 2.345E−06 | 8.496E−06 | −1.908E−04 | −1.580E−03 | −4.272E−04 | −3.913E−01 |
| C | 1.910E−07 | 3.561E−07 | −2.206E−07 | −4.660E−07 | 1.988E−05 | 2.788E−04 | −1.205E−04 | 1.107E−01 |
| D | −4.591E−09 | −7.995E−09 | 8.401E−09 | 1.466E−08 | −1.118E−06 | −2.847E−05 | 3.705E−05 | −4.392E−02 |
| E | 7.263E−11 | 1.176E−10 | −1.736E−10 | −2.803E−10 | 3.654E−08 | 1.816E−06 | −4.378E−06 | 1.884E−02 |
| F | −7.415E−13 | −1.131E−12 | 2.108E−12 | 3.317E−12 | −7.194E−10 | −7.294E−08 | 2.816E−07 | −1.342E−02 |
| G | 4.704E−15 | 6.907E−15 | −1.503E−14 | −2.372E−14 | 8.751E−12 | 1.779E−09 | −1.034E−08 | 1.820E−04 |
| H | −1.683E−17 | −2.438E−17 | 5.830E−17 | 9.389E−17 | −5.743E−14 | −2.399E−11 | 2.039E−10 | 4.925E−03 |
| J | 2.595E−20 | 3.817E−20 | −9.495E−20 | −1.580E−19 | −8.433E−18 | 1.364E−13 | −1.674E−12 | 1.190E−03 |
| L | 0.000E+00 | 0.000E+00 | 0.000E+00 | 0.000E+00 | 0.000E+00 | 0.000E+00 | 0.000E+00 | 2.321E−03 |
| M | 0.000E+00 | 0.000E+00 | 0.000E+00 | 0.000E+00 | 0.000E+00 | 0.000E+00 | 0.000E+00 | −4.694E−03 |
| N | 0.000E+00 | 0.000E+00 | 0.000E+00 | 0.000E+00 | 0.000E+00 | 0.000E+00 | 0.000E+00 | 3.529E−04 |
| O | 0.000E+00 | 0.000E+00 | 0.000E+00 | 0.000E+00 | 0.000E+00 | 0.000E+00 | 0.000E+00 | 1.822E−03 |
| P | 0.000E+00 | 0.000E+00 | 0.000E+00 | 0.000E+00 | 0.000E+00 | 0.000E+00 | 0.000E+00 | 9.608E−04 |
| Surface No | S12 | S13 | S15 | S16 | S17 | S18 | S19 | S20 |
| K | 2.377E+01 | 5.231E+00 | −1.986E+00 | 9.074E+01 | −3.862E+01 | −1.003E+00 | 8.173E−01 | 9.900E+01 |
| A | −2.477E−01 | −2.039E−04 | −1.124E−03 | −5.881E−01 | −4.294E−03 | −1.243E−03 | −1.199E−04 | 1.175E+00 |
| B | −1.601E−01 | 2.905E−05 | 3.747E−04 | 2.108E−01 | 1.081E−03 | 4.360E−04 | 1.000E−04 | 1.438E−01 |
| C | 1.511E−01 | −8.060E−06 | −5.407E−05 | −5.393E−02 | −1.405E−04 | −1.492E−04 | −1.582E−05 | −1.480E−02 |
| D | −2.616E−02 | 9.498E−07 | 4.074E−06 | 4.213E−02 | 1.111E−05 | 2.781E−05 | 1.271E−06 | −3.950E−02 |
| E | −7.810E−03 | −6.561E−08 | −1.771E−07 | −3.926E−02 | −5.578E−07 | −3.024E−06 | −5.922E−08 | −2.740E−02 |
| F | −1.647E−02 | 2.681E−09 | 4.567E−09 | 3.664E−03 | 1.781E−08 | 1.989E−07 | 1.663E−09 | −8.157E−03 |
| G | 3.209E−03 | −6.271E−11 | −6.905E−11 | −8.801E−03 | −3.484E−10 | −7.804E−09 | −2.756E−11 | 4.785E−03 |
| H | 7.648E−03 | 7.722E−13 | 5.658E−13 | 1.395E−02 | 3.787E−12 | 1.680E−10 | 2.441E−13 | 1.046E−02 |
| J | 1.150E−03 | −4.112E−15 | −1.806E−15 | 3.825E−03 | −1.758E−14 | −1.528E−12 | −8.409E−16 | 8.157E−03 |
| L | −7.339E−04 | 0.000E+00 | 0.000E+00 | 8.264E−03 | 0.000E+00 | 0.000E+00 | 0.000E+00 | 3.660E−03 |
| M | −2.572E−03 | 0.000E+00 | 0.000E+00 | 3.941E−03 | 0.000E+00 | 0.000E+00 | 0.000E+00 | 4.776E−04 |
| N | 3.041E−03 | 0.000E+00 | 0.000E+00 | 5.512E−04 | 0.000E+00 | 0.000E+00 | 0.000E+00 | −7.859E−04 |
| O | 3.558E−03 | 0.000E+00 | 0.000E+00 | −4.371E−04 | 0.000E+00 | 0.000E+00 | 0.000E+00 | −5.062E−04 |
| P | 1.296E−03 | 0.000E+00 | 0.000E+00 | −4.186E−04 | 0.000E+00 | 0.000E+00 | 0.000E+00 | −1.150E−04 |

Table 22 below shows the values of various optical characteristics in the first to seventh embodiments in the present disclosure.

TABLE 22

| | 1st | 2nd | 3rd | 4th | 5th | 6th | 7th |
|---|---|---|---|---|---|---|---|
| Value | Emb. | Emb. | Emb. | Emb. | Emb. | Emb. | Emb. |
| air_T12 | 0.159 | 0.160 | 0.151 | 1.781 | 1.800 | 1.777 | 2.165 |
| air_T45 | 0.166 | 0.166 | 0.166 | 0.459 | 0.498 | 0.562 | 0.387 |
| n1 | 1.660 | 1.660 | 1.660 | 1.660 | 1.660 | 1.660 | 1.660 |
| n2 | 1.535 | 1.535 | 1.535 | 1.535 | 1.535 | 1.535 | 1.535 |
| n4 | 1.544 | 1.544 | 1.544 | 1.544 | 1.544 | 1.544 | 1.544 |
| n5 | 1.635 | 1.635 | 1.635 | 1.635 | 1.635 | 1.635 | 1.635 |
| fw | 12.4 | 12.4 | 12.4 | 18.7 | 18.7 | 18.7 | 18.7 |
| ft | 24.7 | 24.7 | 24.7 | 36 | 36 | 36 | 36 |
| Fnow | 2.6 | 2.6 | 2.4 | 2.2 | 2.2 | 2.2 | 2.3 |
| Fnot | 2.7 | 2.7 | 2.5 | 2.3 | 2.3 | 2.3 | 2.4 |
| f1 | −68.368 | −68.223 | −68.643 | −129.087 | −127.879 | −127.879 | −152.131 |
| f2 | 15.529 | 15.902 | 15.805 | 37.631 | 37.519 | 37.519 | 36.372 |
| f3 | −6.320 | −6.338 | −6.342 | −12.654 | −12.594 | −12.594 | −11.320 |
| f4 | −119.662 | −118.838 | −127.512 | −826.040 | −1165.855 | −1165.855 | 135.715 |
| f5 | 49.446 | 46.785 | 50.832 | 45.702 | 43.569 | 43.569 | 55.842 |
| f6 | 7.294 | 7.292 | 7.260 | 13.374 | 13.461 | 13.461 | 15.402 |
| f7 | −8.859 | −8.765 | −8.809 | −14.776 | −14.790 | −14.790 | −17.354 |
| f8 | 9.936 | 9.944 | 9.720 | 19.855 | 19.944 | 19.944 | 16.614 |
| fG1 | 21.047 | 21.685 | 21.520 | 53.884 | 53.748 | 55.277 | 48.256 |
| fG2 | −6.803 | −6.895 | −6.829 | −18.446 | −19.029 | −19.455 | −16.347 |
| fG3 | 14.474 | 14.979 | 14.774 | 34.094 | 34.694 | 35.871 | 45.775 |
| fG4 | 9.965 | 9.974 | 9.749 | 19.916 | 20.005 | 19.842 | 16.662 |
| fc | −6.320 | −6.338 | −6.342 | −12.654 | −12.594 | −12.594 | −11.320 |
| L8sag_1/2 | −0.193 | −0.015 | −0.193 | −0.080 | −0.086 | −0.055 | 0.029 |
| L8sag_1 | −0.908 | −0.283 | −0.908 | −0.721 | −0.845 | −0.423 | −0.063 |
| DS | 19.426 | 19.380 | 19.477 | 44.800 | 43.535 | 44.188 | 37.867 |
| TTL | 35.001 | 35.019 | 35.000 | 72.900 | 71.673 | 72.900 | 66.493 |

In Table 22 above, ft denotes the total focal length of the optical imaging system in the telephoto mode, Fnow denotes the f-number of the optical imaging system in the wide-angle mode, and Fnot denotes the f-number of the optical imaging system in the telephoto mode.

Table 23 below shows the values of Conditional Expressions 1 to 12 in the first to seventh embodiments in the present disclosure.

TABLE 23

| Cond. | | 1st | 2nd | 3rd | 4th | 5th | 6th | 7th |
|---|---|---|---|---|---|---|---|---|
| Exp. | Value | Emb. | Emb. | Emb. | Emb. | Emb. | Emb. | Emb. |
| 1 | air_T12 | 0.159 | 0.160 | 0.151 | 1.781 | 1.800 | 1.777 | 2.165 |
| 2 | air_T45 | 0.166 | 0.166 | 0.166 | 0.459 | 0.498 | 0.562 | 0.387 |
| 3 | n1 − n2 | 0.125 | 0.125 | 0.125 | 0.125 | 0.125 | 0.125 | 0.125 |
| 4 | n5 − n4 | 0.091 | 0.091 | 0.091 | 0.091 | 0.091 | 0.091 | 0.091 |
| 5 | fw/f2 | 0.7985 | 0.7798 | 0.7846 | 0.4969 | 0.4984 | 0.4984 | 0.5141 |
| 6 | fw/f5 | 0.2508 | 0.2650 | 0.2439 | 0.4092 | 0.4292 | 0.4292 | 0.3349 |
| 7 | L8Sag_1 − | −0.715 | −0.268 | −0.715 | −0.641 | −0.759 | −0.368 | −0.092 |
| | L8Sag_1/2 | | | | | | | |
| 8 | DS/TTL | 0.5550 | 0.5534 | 0.5565 | 0.6145 | 0.6074 | 0.6061 | 0.5695 |
| 9 | DS/fG1 | 0.9230 | 0.8937 | 0.9051 | 0.8314 | 0.8100 | 0.7994 | 0.7847 |
| 10 | fc/fG2 | 0.9290 | 0.9192 | 0.9287 | 0.6860 | 0.6618 | 0.6473 | 0.6925 |
| 11 | fG1/fG2 | −3.0938 | −3.1450 | −3.1513 | −2.9212 | −2.8245 | −2.8413 | −2.9520 |
| 12 | fG2/fG3 | −0.4700 | −0.4603 | −0.4622 | −0.5410 | −0.5485 | −0.5424 | −0.3571 |

The optical imaging system according to embodiments in the present disclosure may implement a zoom function by varying the focal length.

While this disclosure includes specific examples, it will be apparent after an understanding of the disclosure of this application that various changes in form and details may be made in these examples without departing from the spirit and scope of the claims and their equivalents. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An optical imaging system comprising:
a first lens group, a second lens group, a third lens group, and a fourth lens group sequentially arranged in ascending numerical order along an optical axis of the optical imaging system from an object-side of the optical imaging system toward an imaging plane of the optical imaging system; and
a reflective member disposed between the first lens group and the second lens group,
wherein the second lens group and the fourth lens group are each configured to be movable along the optical axis,
the first lens group has a positive refractive power, and
the optical imaging system satisfies the following conditional expression:
$$- 3.5 < fG 1 / fG 2 < - 2$$
where fG1 is a focal length of the first lens group, and fG2 is a focal length of the second lens group.

2. The optical imaging system of claim 1, wherein the first lens group comprises a first lens and a second lens sequentially arranged in ascending numerical order along the optical axis from an object side of the first lens group toward the imaging plane, and
one of the first lens and the second lens has an Abbe number of 50 or more, and another one of the first lens and the second lens has an Abbe number of 25 or less.

3. The optical imaging system of claim 2, wherein the first lens and the second lens have refractive powers of opposite signs, and
among the first lens and the second lens, the lens having an Abbe number of 50 or more has a positive refractive power, and the lens having an Abbe number of 25 or less has a negative refractive power.

4. The optical imaging system of claim 2, wherein the optical imaging system satisfies the following conditional expression:
$$0.1 < air\_T12 < 2.5$$
where air_T12 is a distance along the optical axis from an image-side surface of the first lens to an object-side surface of the second lens.

5. The optical imaging system of claim 2, wherein the optical imaging system satisfies the following conditional expression:
$$0. 1 < fw / f 2 < 2.0$$
where fw is a total focal length of the optical imaging system in a wide-angle mode, and f2 is a focal length of the second lens.

6. The optical imaging system of claim 1, wherein the second lens group has a negative refractive power and comprises a plurality of lenses, and one of the plurality of lenses of the second lens group has a biconcave shape.

7. The optical imaging system of claim 6, wherein the optical imaging system satisfies the following conditional expression:
$$0.6 < fc / fG 2 < 1.0$$
where fc is a focal length of the lens having the biconcave shape among the plurality of lenses of the second lens group, and fG2 is the focal length of the second lens group.

8. The optical imaging system of claim 1, wherein the second lens group comprises a third lens, a fourth lens, and a fifth lens sequentially arranged in ascending numerical order along the optical axis from an object side of the second lens groups toward the imaging plane, and
the optical imaging system satisfies the following conditional expression:
$$0.1 < air\_T45 < 1.0$$
where air_T45 is a distance along the optical axis from an image-side surface of the fourth lens to an object-side surface of the fifth lens.

9. The optical imaging system of claim 8, wherein the optical imaging system satisfies the following conditional expression:
$$0.1 < fw / f 5 < 2.0$$
where fw is a total focal length of the optical imaging system in a wide-angle mode, and f5 is a focal length of the fifth lens.

10. The optical imaging system of claim 1, wherein the first lens group comprises a first lens and a second lens sequentially arranged in ascending numerical order along the optical axis from an object side of the first lens group toward the imaging plane,
the second lens group comprises a third lens, a fourth lens, and a fifth lens sequentially arranged in ascending numerical order along the optical axis from an object side of the second lens group toward the imaging plane, and
the optical imaging system satisfies the following conditional expressions:
$$0.1 < n 1 - n 2 < 0.2$$
$$0.08 < n 5 - n 4 < 0.2$$
where n1 is a refractive index of the first lens, n2 is a refractive index of the second lens, n4 is a refractive index of the fourth lens, and n5 is a refractive index of the fifth lens.

11. The optical imaging system of claim 1, wherein the third lens group and the fourth lens group each have a positive refractive power.

12. The optical imaging system of claim 1, wherein the optical imaging system further comprises a stop disposed between the second lens group and the third lens group,
he third lens group comprises a plurality of lenses, and
among the plurality of lenses of the third lens group, a lens disposed closest to the stop has a positive refractive power.

13. The optical imaging system of claim 12, wherein the optical imaging system satisfies the following conditional expression:
$$0.4 < DS / TTL < 0.65$$
where DS is a distance along the optical axis from an object-side surface of the first lens group to the stop, and TTL is a distance along the optical axis from the object-side surface of the first lens group to the imaging plane.

14. The optical imaging system of claim 12, wherein the optical imaging system satisfies the following conditional expression:
$$0.45 < DS / fG 1 < 1.0$$
where DS is a distance along the optical axis from an object-side surface of the first lens group to the stop, and fG1 is a focal length of the first lens group.

15. The optical imaging system of claim 1, wherein the optical imaging system satisfies the following conditional expression:
$$- 0.6 < fG 2 / fG 3 < - 0.2$$
where fG2 is the focal length of the second lens group, and fG3 is the focal length of the third lens group.

16. The optical imaging system of claim 1, wherein the first lens group comprises a first lens and a second lens sequentially arranged in ascending numerical order along the optical axis of from an object-side of the first lens group toward the imaging plane,
the second lens group comprises a third lens, a fourth lens, and a fifth lens sequentially arranged in ascending numerical order along the optical axis of from an object-side of the second lens group toward the imaging plane,
the third lens group comprises a sixth lens and a seventh lens sequentially arranged in ascending numerical order along the optical axis of from an object-side of the third lens group toward the imaging plane,
the fourth lens group comprises an eighth lens, and
the optical imaging system satisfies the following conditional expression:
$$- 0.9 < L8Sag\_ 1 - L8Sag\_ 1 / 2 < - 0.01$$
where L8Sag_1 is a sag value of an object-side surface of the eighth lens at an effective diameter of the object-side surface of the eighth lens, and L8Sag_1/2 is a sag value of the object-side surface of the eighth lens at one half of the effective diameter of the object-side surface of the eighth lens.
